(19) United States
(12) Patent Application Publication
(10) Pub. No.: US 2008/0139204 A1
(43) Pub. Date: Jun. 12, 2008

(54) WIRELESS NETWORK HANDOVER APPARATUS, METHOD, AND COMPUTER READABLE MEDIUM FOR DYNAMIC HANDOVER

(75) Inventors: Chih-Chiang Hsieh, Kaohsiung County (TW); Chih-Chen Yang, Tainan (TW); Hua-Chiang Yin, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/683,516

(22) Filed: Mar. 8, 2007

(30) Foreign Application Priority Data
Dec. 6, 2006 (TW) 095145454

(51) Int. Cl. H04Q 7/20

(52) U.S. Cl. 455/436

(57) ABSTRACT

A wireless network handover apparatus receives a request signal from a mobile apparatus and then allocates services of the base stations to the mobile apparatus according to the request signal. After allocation, the handover apparatus transmits a report signal to other base stations via a handover gateway. Therefore, services of the base stations can be efficiently allocated to the mobile apparatus.

This application claims the benefit of priority based on Taiwan Patent Application No. 095145454 filed on Dec. 6, 2006 of which the contents are incorporated herein by reference in its entirety.

### CROSS-REFERENCES TO RELATED APPLICATIONS

Not applicable.

### BACKGROUND OF THE INVENTION

1. Field of the Invention

The present invention relates to a wireless network handover apparatus, a method, and a computer readable medium; specifically, it relates to a wireless network handover apparatus, a method, and a computer readable medium for dynamic handover.

2. Descriptions of the Related Art

With popular and various applications of every kind of electronic wireless apparatuses, it is obvious that the electronic wireless apparatus often provides different kinds of services simultaneously. For a mobile phone as an example, most of current mobile phones provide the functionality of internet access. Consequently, while a user is calling for talk, the user is possibly downloading data using a FTP (File Transfer Protocol) or sending a short message using the mobile phone simultaneously. Therefore, the same mobile phone provides three kinds of service at the same time. After the mobile phone leaves the signal coverage range of the original base station that provides services, the mobile phone must receive the connection services provided by other base stations, or the communications on the mobile phone will be interrupted which causes inconvenience to users. Although currently one mobile phone can provide a lot of services, however, all the connection services must be provided by the same base station. Consequently, if one base station cannot provide all the services, the connection services in progressing for the user are forced to be interrupted or the user may only use a fewer number of services provided by the base station.

When the user is under the moving condition, it is possible that the user will face a wireless network handover problem as mentioned above because the user moves out the coverage range of the base station that provides the original services. The following illustrates some kinds of problems that will occur when each base station cannot provide all the connection services. FIG. 1 shows a schematic diagram of conventional mobile phone handover architecture 1 which comprises a base station 10, a base station 11, a base station 12 and a mobile phone 13. In this conventional example, the base station 10 and the base station 11 can provide three kinds of services such as a speech communication C1, a data communication C2 and a short message service C3, while the base station 12 can only provide the speech communication Cl and the short message service C3.

At first, the mobile phone 13 is located within the signal coverage range of services provided by the base station 10. Therefore, the base station 10 provides a connection 14 for the mobile phone 13. By utilizing the connection 14, the mobile phone 13 uses three kinds of services simultaneously. When the mobile phone 13 moves to the signal coverage ranges of the base station 11 and the base station 12 along a moving path 15, a connection 16 between the base station 11 and the mobile phone 13 is built if the base station 11 can provide a better service quality. Then the mobile phone 13 can use the services provided by the base station 11 via the connection 16.

If the mobile phone 13 moves along the moving path 15 continuously, the mobile phone 13 will leave the service signal coverage range of the base station 10 gradually and the communication signal quality between is getting worse. When the mobile phone 13 is located at a position that only the base station 12 can provide services only, since the base station 12 has not enough resources to provide three kinds of services simultaneously, the original speech communication C1, data communication C2 and short message service C3 built between the mobile phone 13 and the base station 10 will be interrupted simultaneously until entering the signal coverage range of the base station 11. Only when the resources of the base station 11 are capable of simultaneously providing the speech communication C1, the data communication C2 and the short message service C3, the mobile phone 13 can reuse three services provided by the base station 11 via the connection 16.

From the aforementioned example, all base stations must provide the required resources of services C1, C2 and C3 simultaneously to perform the handover in the conventional mobile phone handover architecture 1. This leads to inconvenience that the speech communication is forced to be interrupted possibly due to a bad overlapping of the signal coverage ranges among base stations while the user is using the speech communication service. On the other hand, the mobile phone cannot perform the handover operation for services C1, C2 and C3 to different base stations to utilize the resources of each base station efficiently and to maintain a better service quality provided by base stations according to the connection intensities of each base station. Consequently, how to switch services dynamically to different base stations according to the connection intensities, such as the speech communication C1 being provided by the base station 12, the data communication C2 and the short message service C3 being provided by the base station 10, to effectively utilize the resources of each base station and to prevent user required services from being interrupted as possible to further enhance utilization ratios of all base stations is still an objective for the industry to endeavor.

### SUMMARY OF THE INVENTION

One objective of this invention is to provide a handover apparatus of a wireless network. The apparatus comprises a receiving module and a transmission module. The receiving module is used for receiving a report signal and a first confirmation signal from a first base station. The transmission module is used for transmitting a handover respond signal to the first base station according to the report signal and transmitting a handover confirmation signal to the first base station according to the first confirmation signal. The first base station is one of a plurality of base stations providing a wireless apparatus with the wireless network services.

Another objective of this invention is to provide a handover method of a wireless network, comprising steps of: receiving a report signal from a first base station; transmitting a handover respond signal to the first base station according to the report signal; receiving a first confirmation signal from the first base station; and transmitting a handover confirmation signal to the first base station according to the first confirmation signal; wherein the first base station is one of a plurality of base stations providing a wireless apparatus with the wireless network services.

Yet a further objective of the invention is to provide a computer readable medium for storing a computer program. The computer program makes a wireless network handover apparatus execute a handover method of a wireless network. The method comprises steps of: making a receiving module receive a report signal from a first base station; making a transmission module transmit a handover respond signal to the first base station according to the report signal; making the receiving module receive a first confirmation signal from the first base station; and making the transmitting module transmit a handover confirmation signal to the first base station according to the first confirmation signal; wherein the first base station is one of a plurality of base stations providing a wireless apparatus with the wireless network services.

Yet a further objective of the invention is to provide a handover control apparatus of a wireless network, comprising a receiving module and a transmission module. The receiving module is used for receiving a handover request signal and a determination signal from a wireless apparatus, and receiving a handover respond signal and an allocation signal from a handover gateway. The transmission module is used for transmitting a report signal to the handover gateway according to the handover request signal, transmitting a confirmation signal to the handover gateway according the determination signal, and transmitting the handover respond signal to the wireless apparatus. The receiving module allocates the service resource according to the allocation signal.

Yet a further objective of the invention is to provide a handover control method of a wireless network, comprising steps of: receiving a handover request signal from a wireless apparatus; transmitting a report signal to a handover gateway according to the handover request signal; receiving a handover respond signal from the handover gateway; transmitting the handover respond signal to the wireless apparatus; receiving a determination signal from the wireless apparatus; transmitting a confirmation signal to the handover gateway according to the determination; receiving an allocation signal from the handover gateway; and allocating the service resource according to the allocation signal.

Yet a further objective of the invention is to provide a computer readable medium for storing a computer program. The computer program makes a wireless network handover apparatus execute a handover control method of a wireless network. The method comprises steps of: making a receiving module receive a handover request signal from a wireless apparatus; making a transmission module transmit a report signal to a handover gateway according to the handover request signal; making the receiving module receive a handover respond signal from the handover gateway; making the transmission module transmit the handover respond signal to the wireless apparatus; making the receiving module receive a determination signal from the wireless apparatus; making the transmission module transmit a confirmation signal to the handover gateway according to the determination; making the receiving module receive an allocation signal from the handover gateway; and making the receiving module allocate the service resource according to the allocation signal.

The invention can effectively solve the problem of the conventional technique which is unable to execute the handover operation dynamically and leads to that while the user is using the wireless apparatus, the user must wait until the base station confirms all service resources are provided to perform the handover operation. The invention can perform the handover for the services of the wireless apparatus to each of the base stations according to the connection intensity of each of the base stations and a connection service order that the user intends for reserved priority. Not only resources of each of the base stations can be utilized effectively, but also services of the wireless apparatus can ensure the service quality without been interrupted as possible to enhance an overall performance of the wireless services.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of conventional handover architecture of a mobile phone;

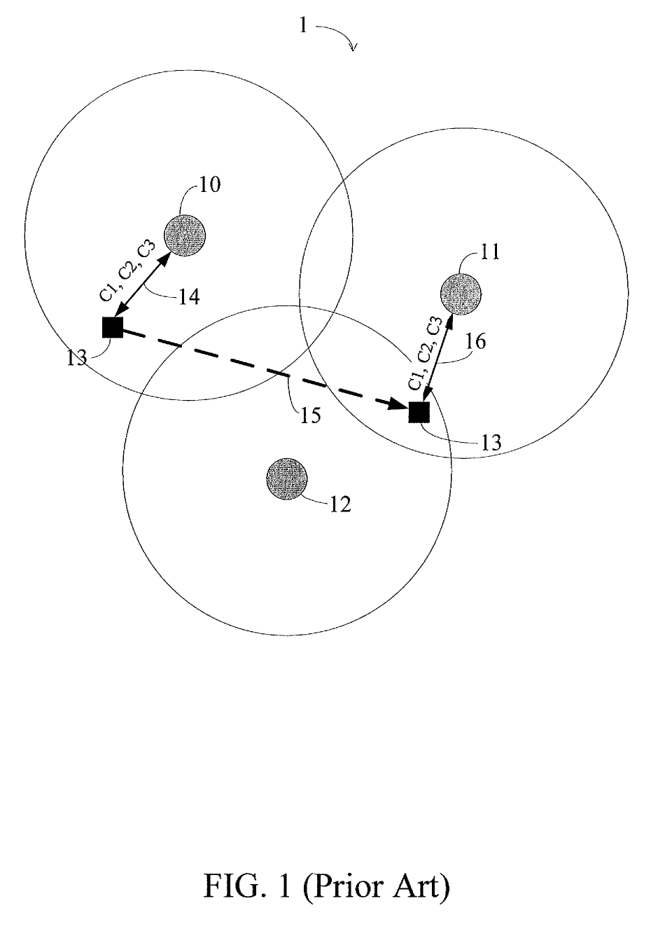

FIG. 2 is a schematic diagram of a first embodiment of the invention;

FIG. 3 is a schematic diagram of a base station of a first embodiment of the invention;

FIG. 4 is a schematic diagram of a handover gateway of a first embodiment of the invention;

FIG. 5 is a schematic diagram of a confirmation process 205 operation of a first embodiment of the invention;

FIG. 6 is a schematic diagram of a confirmation process 205 operation of a first embodiment of the invention;

FIG. 7 is a schematic diagram of a confirmation process 205 operation of a first embodiment of the invention;

FIG. 8 is a schematic diagram of a reservation process 215 operation of a first embodiment of the invention;

FIG. 9 is a schematic diagram of a reservation process 215 operation of a first embodiment of the invention;

FIG. 10 is a schematic diagram of an allocation process 218 operation of a first embodiment of the invention;

FIG. 11 is a schematic diagram of an allocation process 218 operation of a first embodiment of the invention;

FIG. 12 is a schematic diagram of a second embodiment of the invention;

FIG. 13 is a schematic diagram of a reservation process 1204 operation of a second embodiment of the invention;

FIG. 14 is a schematic diagram of a third embodiment of the invention;

FIG. 15 is a schematic diagram of a fourth embodiment of the invention;

FIG. 16A is a flow chart of a fifth embodiment of the invention;

FIG. 16B is a flow chart of a fifth embodiment of the invention;

FIG. 16C is a flow chart of a fifth embodiment of the invention;

FIG. 17 is a flow chart of step 1600 of a fifth embodiment of the invention;

FIG. 18 is a flow chart of step 1600 of a fifth embodiment of the invention;

FIG. 19 is a flow chart of step 1600 of a fifth embodiment of the invention;

FIG. 20 is a flow chart of step 1607 of a fifth embodiment of the invention;

FIG. 21 is a flow chart of step 1607 of a fifth embodiment of the invention;

FIG. 22 is a flow chart of step 1616 of a fifth embodiment of the invention;

FIG. 23 is a flow chart of step 1616 of a fifth embodiment of the invention;

FIG. 24A is a flow chart of a sixth embodiment of the invention;

FIG. 24B is a flow chart of a sixth embodiment of the invention;

FIG. 24C is a flow chart of a sixth embodiment of the invention;

FIG. 25 is a flow chart of step 2404 of a sixth embodiment of the invention;

FIG. 26A is a flow chart of a seventh embodiment of the invention;

FIG. 26B is a flow chart of a seventh embodiment of the invention;

FIG. 26C is a flow chart of a seventh embodiment of the invention;

FIG. 27A is a flow chart of an eighth embodiment of the invention;

FIG. 27B is a flow chart of an eighth embodiment of the invention; and

FIG. 27C is a flow chart of an eighth embodiment of the invention.

### DESCRIPTION OF THE PREFERRED EMBODIMENT

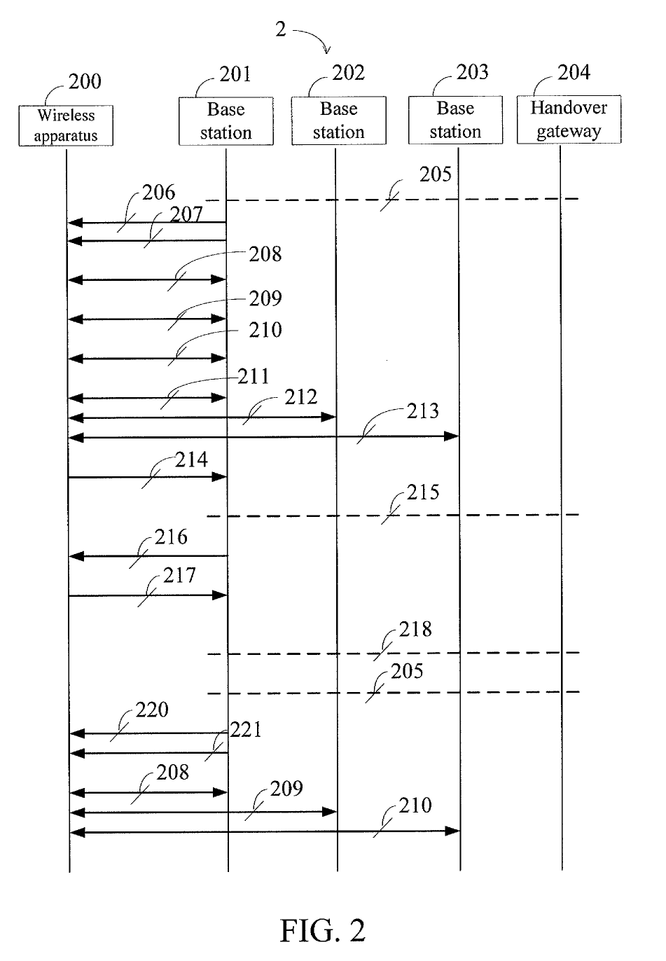

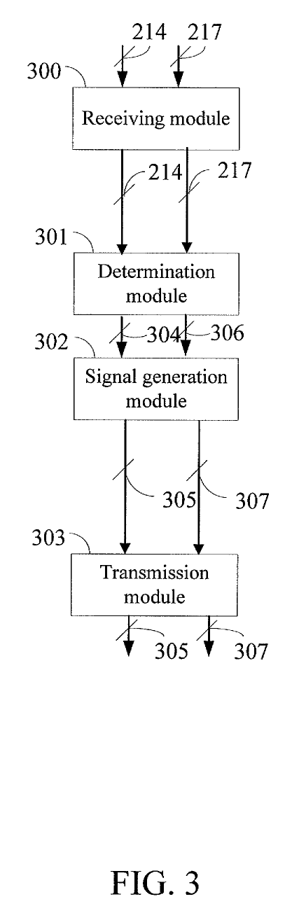

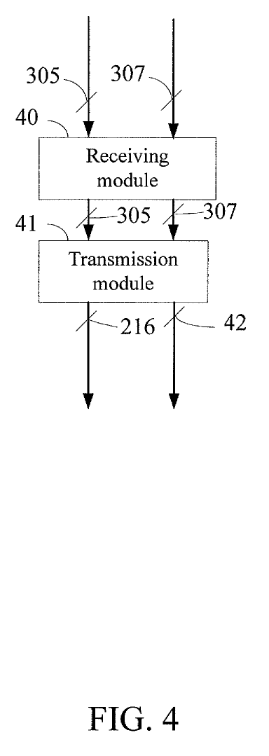

A first embodiment of the invention is shown in FIG. 2 which is a handover system 2 conforming to a WiMAX wireless network specification. The system comprises a wireless apparatus 200, a base station 201, a base station 202, a base station 203 and a handover gateway 204. A schematic diagram of the base station is shown in FIG. 3. Each of the base stations 201, 202 and 203 comprises a receiving module 300, a determination module 301, a signal generation module 302 and a transmission module 303. Please also refer to FIG. 4. The handover gateway 204 comprises a receiving module 40 and a transmission module 41.

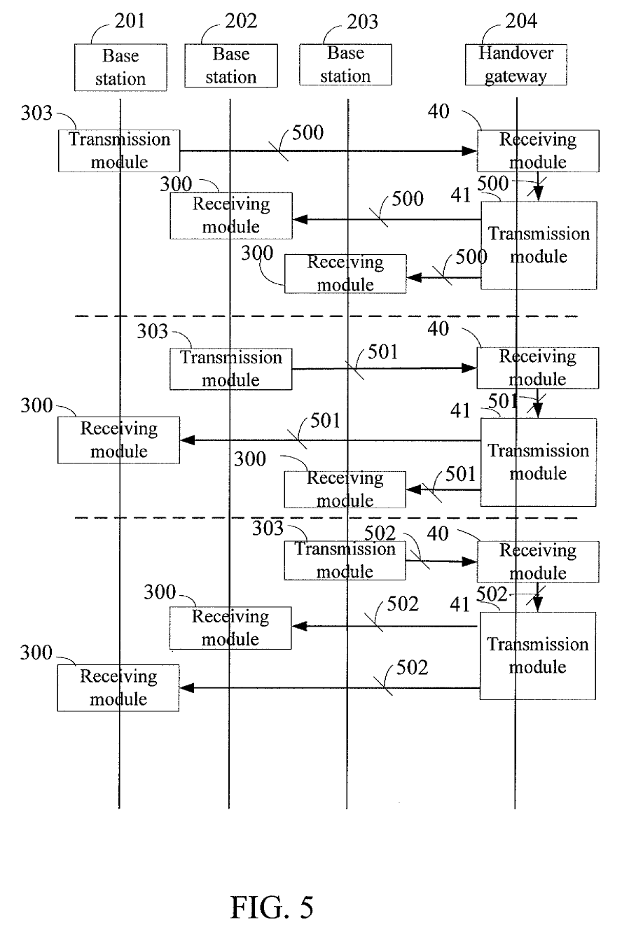

At first, each of the base stations has to confirm current conditions of each base station (such as resource usage, upload and download information, and provided services, etc.) with each other. A confirmation procedure 205 can be referred in FIG. 5. In FIG. 5, the base station 201 first transmits an update signal 500 to the handover gateway 204 via the transmission module 303, wherein the update signal 500 comprises the information of current conditions of the base station 201. The handover gateway 204 receives the update signal 500 via the receiving module 40 and transmits the update signal 500 immediately to the base station 202 and the base station 203 respectively via the transmission module 41. Each of the base station 202 and the base station 203 will receive the update signal 500 via individual receiving module 300. With the aforementioned series of signal transmissions, the base station 202 and the base station 203 can obtain current conditions of the base station 201. Similarly, the base station 202 and the base station 203 will separately transmit update signals to the handover gateway 204, such as an update signal 501 and an update signal 502 as shown in FIG. 5. The handover gateway 204 then individually transmits the update signal 501 and the update signal 502 to other base stations. The operations are the same as the transmission procedure between the base station 201 and the handover gateway 204 and thus not repeated here.

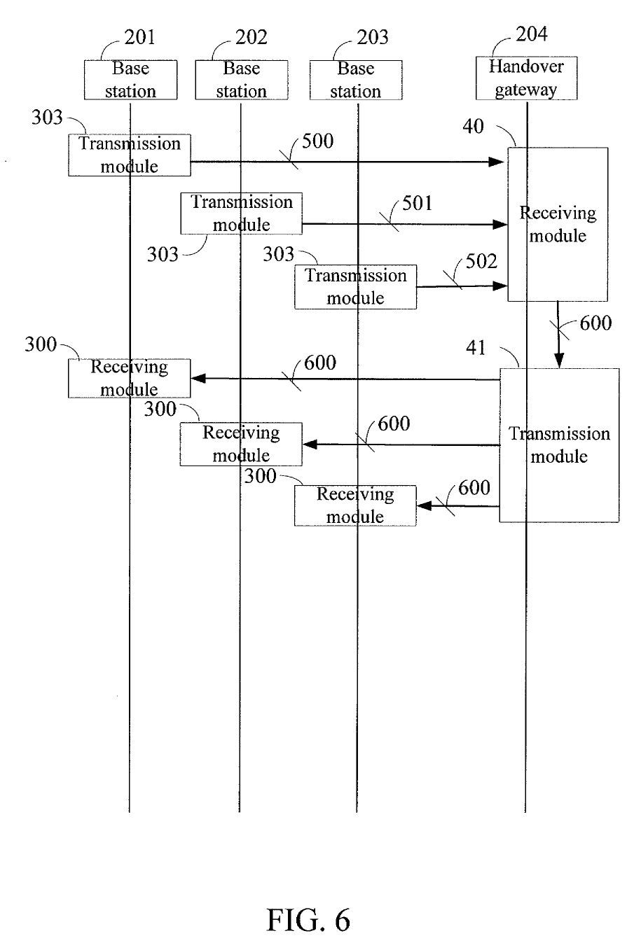

The confirmation procedure 205 can also be referred in FIG. 6. At first, the base stations 201, 202 and 203 transmit the update signals 500, 501 and 502 to the handover gateway 204 via individual transmission module 303, respectively. The handover gateway 204 individually receives and stores the update signals 500, 501 and 502 via the receiving module 40. After a specific period of time, the handover gateway 204 transmits an integration signal 600 to the base stations 201, 202 and 203, wherein the integration signal 600 comprises the information of the stored update signals 500, 501 and 502. With the aforementioned series of signal transmissions, the base stations 201, 202 and 203 can obtain current conditions of each base station.

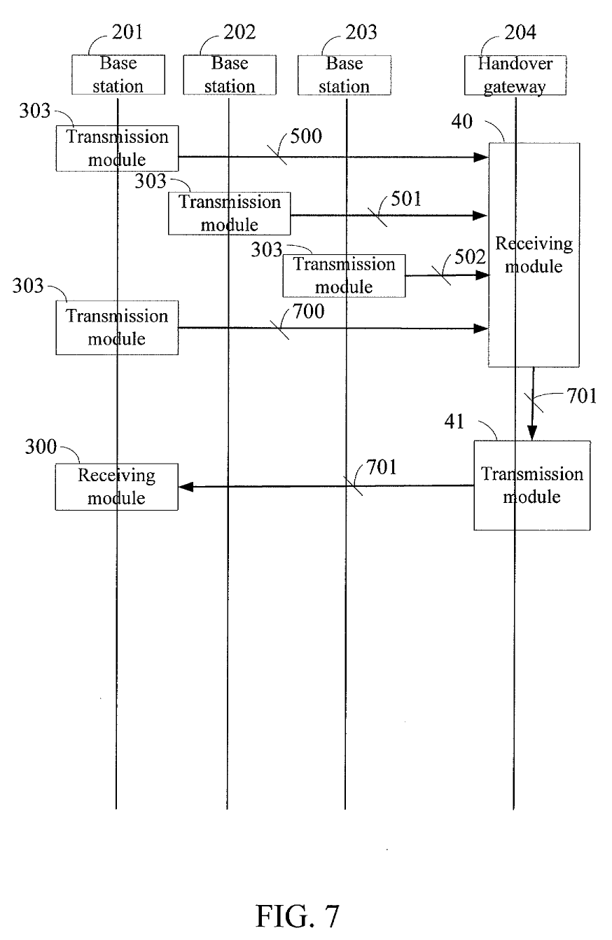

The confirmation procedure 205 can be further referred in FIG. 7. At first, the base stations 201, 202 and 203 transmit the update signals 500, 501 and 502 to the handover gateway 204 via individual transmission module 303, respectively. The handover gateway 204 individually receives and stores the update signals 500, 501 and 502 via the receiving module 40. Later, if one base station transmits an update request signal 700 to the handover gateway 204, the handover gateway 204 then transmits the stored conditions of each base station via an integration signal 701 to the base station that transmits the update request signal 700, wherein the integration signal 701 comprises the information of the stored update signals 500, 501 and 502. For the base station 201 as an example, the base station 201 transmits the update request signal 700 to the handover gateway 204 via the transmission module 303. The handover gateway 204 receives the update request signal 700 via the receiving module 40 and transmits the integration signal 701 to the base station 201 via the transmission module 41, wherein the integration signal 701 comprises the information of the stored update signals 500, 501 and 502. Similarly, the base station 202 and the base station 203 can individually transmit the update signals to the handover gateway 204. The handover gateway 204 then transmits the integration signal 701 to the base station 202 and the base station 203 individually. The operations are the same as the base station 201 and thus not repeated here.

Please keep on referring to FIG 2. In the first embodiment, it is assumed that the base station 201 is a main base station. After completing the aforementioned condition update of each base station, the base station 201 will transmit an upload signal 206 and a download signal 207 to the wireless apparatus 200, wherein the upload signal 206 comprises all required information related to upload, and the download signal 207 comprises all required information related to download. The wireless apparatus 200 can communicate with the base stations 201, 202 and 203 only after it obtains the necessary information. The detailed content of the upload signal 206 and the download signal 207 conforms to the WiMAX wireless specification and is not repeated here.

In the first embodiment, three services provided by one base station for one wireless apparatus will be distributed to three different base stations via the handover operation. For example, the base station 201 provides services 208, 209 and 210 for the wireless apparatus 200. In this embodiment, all base stations that provide services for the wireless apparatus 200 before the handover operation are called a first service group. Here the base station 201 is the first service group. The wireless apparatus 200 transmits the measurement signals 211, 212 and 213 to detect signal intensities of the wireless networks of the base stations 201, 202 and 203, respectively. The technique for detecting signal intensity is already defined by the WiMAX wireless network specification and thus not repeated here. After obtaining the signal intensity information of each base station, the wireless apparatus 200 can change the base station of providing services according to the signal intensity information of each base station. Consequently, the wireless apparatus 200 transmits a handover request signal 214 to the base station 201, wherein the handover request signal 214 comprises the information of the wireless network connection intensity, the service bandwidth and the priority of data connection of the wireless apparatus, etc.

Please refer to FIG. 3. After the wireless apparatus 200 transmits the handover request signal 214, the base station 201 receives the handover request signal 214 via the receiving module 300, wherein the handover request signal 214 comprises the information of wireless network connection intensity, the service bandwidth and the priority of data connection of the wireless apparatus, etc. The determination module 301 then determines whether to accept the request of the handover request signal 214 according to the resource conditions of the handover request signal 214 and the base stations. If not, the base station 201 maintains current state for providing services. If yes, for example it is assumed that the wireless network connection intensity of the base station 201 is 5 and the remaining resources is 2, the wireless network connection intensity of the base station 202 is 10 and the remaining resources is 5, the wireless network connection intensity of the base station 203 is 15 and the remaining resources is 3; and the resources and priorities required by services 207, 208 and 209 are (6,3), (4,1) and (2,2), respectively. In the first embodiment, the smaller priority number represents the higher priority; the larger number of the wireless network connection intensity, represents the stronger signal intensity.

At first, the priority ordering is considered to allocate the service 207, the service 208 and the service 209 to the base station 201, the base station 203 and the base station 202 for providing the service, respectively. Next, it is considered that whether the remaining resources of each base station are capable of providing the related services. Consequently, the determination module 301 finally allocates the service 207, the service 208 and the service 209 to the base station 201, the base station 202 and the base station 203 and transmits an enable signal 304 to the signal generation module 302. The signal generation module 302 generates a report signal 305 according to the enable signal 304. The base station 201 then transmits the report signal 305 to the handover gateway 204 via the transmission module 303.

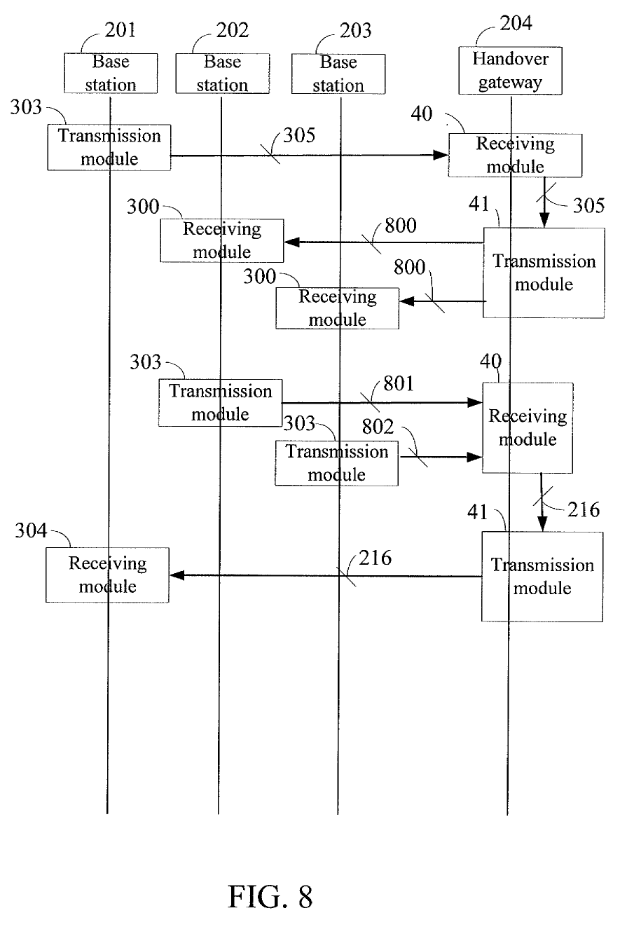

After the base station 201 transmits the report signal 305 via the transmission module 303, the base station 201, the base station 202, the base station 203 and the handover gateway 204 can perform the operations of a reservation procedure 215 as referred in FIG. 8. The handover gateway 204 receives the report signal 305 via the receiving module 40. The transmission module 41 then transmits a request signal 800 to the base station 202 and the base station 203 according to the report signal 305. The base station 202 and the base station 203 receive the request signal 800 via individual receiving module 300 and reserve the required resources for providing the later services according to the request signal 800. The base station 202 and the base station 203 then respectively transmit a confirmation signal 801 and a confirmation signal 802 to the handover gateway 204 via individual transmission module 303. The handover gateway 204 receives the confirmation signal 801 and the confirmation signal 802 via the receiving module 41, wherein the confirmation signal 801 and the confirmation signal 802 are used for confirming that the base station 202 and the base station 203 reserved the required resources for providing the later services. Finally, the handover gateway 204 transmits a handover respond signal 216 to the base station 201 via the transmission module 41. The base station 201 receives the handover respond signal 216 via the receiving module 300.

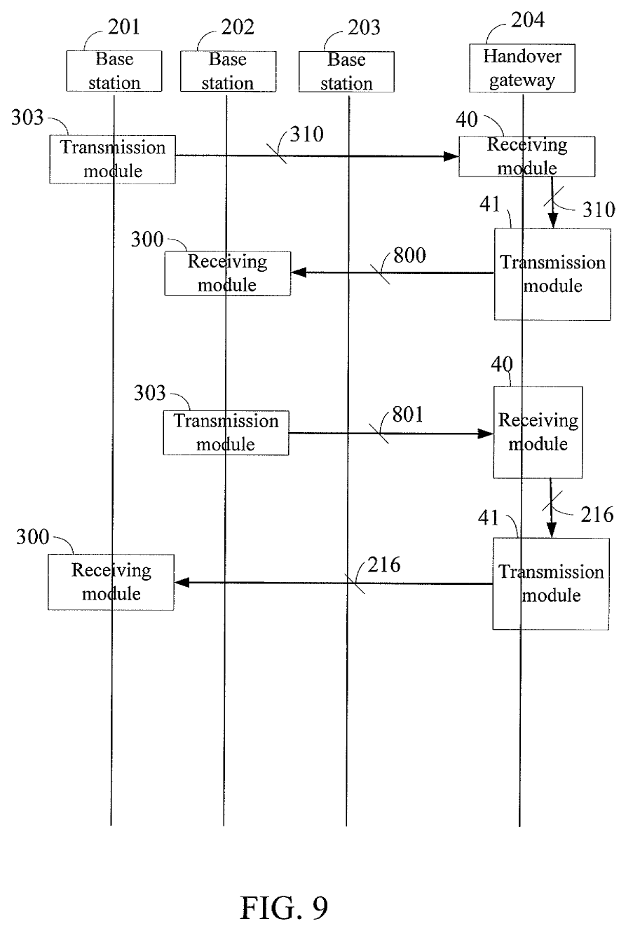

The reservation procedure 215 can also be shown in FIG. 9. In FIG. 9, the handover gateway 204 receives the report signal 305 via the receiving module 40. The transmission module 41 then transmits the request signal 800 to the base station 202 according to the report signal 305. The base station 202 receives the request signal 800 via the receiving module 300 and reserves the required resources for providing the later services according to the request signal 800. The base station 202 then transmits the confirmation signal 801 to the handover gateway 204 via the transmission module 303. The handover gateway 204 receives the confirmation signal 801 via the receiving module 40, wherein the confirmation signal 801 is used for confirming that the base station 202 has reserved the required resources for providing the later services. Next, the handover gateway 204 transmits the handover respond signal 216 to the base station 201 via the transmission module 41. The base station 201 receives the handover respond signal 216 via the receiving module 300. Next, the handover gateway 204 repeats the aforementioned operations to complete the confirmation of the base station 203.

Please keep on referring to FIG. 2. After the base station 201 receives the handover respond signal 216 via the receiving module 300, the base station 201 transmits the handover respond signal 216 to the wireless apparatus 200 via the transmission module 303. The wireless apparatus 200 will determine whether to accept the allocation of the handover respond signal 216 and transmit a determination signal 217 to the base station 201 according to the determination result. Please refer to FIG. 3. The base station 201 receives the determination signal 217 via the receiving module 300 and determines whether the wireless apparatus 200 accepts the allocation of the handover respond signal 216 according to the determination signal 217 via the determination module. If not, the base station 201 does not change current state of servicing and continues to provide services 208, 209 and 210. If yes, an enable signal 306 is generated to the signal generation module 302. Next, the signal generation module 302 generates a first confirmation signal 307 according to the enable signal 306. The base station 201 transmits the first confirmation signal 307 to the handover gateway 204 via the transmission module 303.

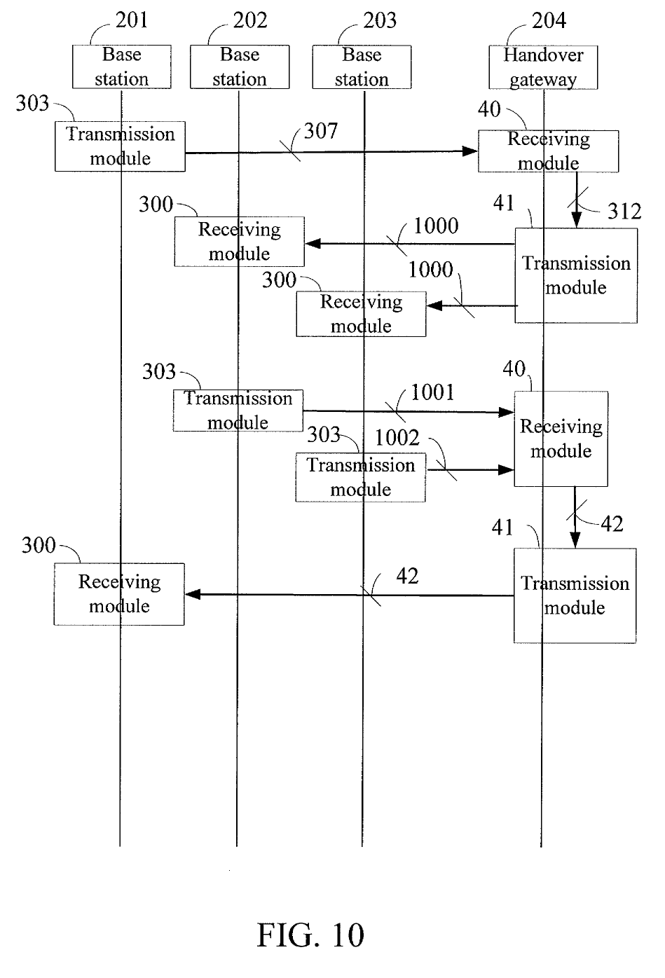

After the base station 201 transmits the first confirmation signal 307 to the handover gateway 204 via the transmission module 303, the base station 201, the base station 202, the base station 203, and the handover gateway 204 will perform the operations of an allocation procedure 218. Please refer to FIG. 10. The handover gateway 204 receives the first confirmation signal 307 via the receiving module 40. Next, the transmission module 41 transmits an allocation signal 1000 to the base station 202 and the base station 203 according to the first confirmation signal 307. The base station 202 and the base station 203 receive the allocation signal 1000 via individual receiving module 300 and allocate the required resources for providing services according to the allocation signal 1000. Next, the base station 202 and the base station 203 respectively transmit a confirmation signal 1001 and a confirmation signal 1002 to the handover gateway 204 via individual transmission module 303. The handover gateway 204 receives the confirmation signal 1001 and the confirmation signal 1002 via the receiving module 40, wherein the confirmation signal 1001 and the confirmation signal 1002 are used for confirming that the base station 202 and the base station 203 allocated the reserved resources required for providing services. Finally, the handover gateway 204 transmits a handover confirmation signal 42 to the base station 201 via the transmission module 41. The base station 201 receives the handover confirmation signal 42 via the receiving module 308.

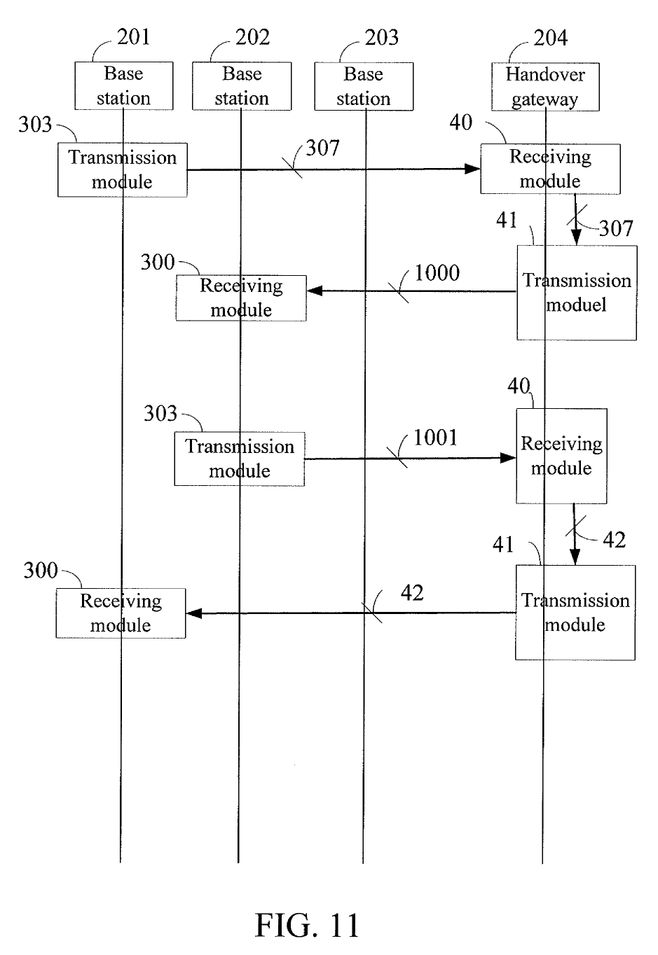

The operations of the allocation procedure 218 can also be the same operations shown in FIG. 11. In FIG. 11, the handover gateway 204 receives the first confirmation signal 307 via the receiving module 40. Next, the transmission module 41 transmits the allocation signal 1000 to the base station 202 according to the first confirmation signal 307. The base station 202 receives the allocation signal 1000 via the receiving module 300 and allocates the reserved sources required for providing services according to the allocation signal 1000. Next, the base station 202 transmits the confirmation signal 1001 to the handover gateway 204 via the transmission module 303. The handover gateway 204 receives the confirmation signal 1001 via the receiving module 40, wherein the confirmation signal 1001 is used for confirming that the base station 202 allocated the reserved resources required for proving services. Finally, the handover gateway 204 will transmit the handover confirmation signal 42 to the base station 201 via the transmission module 41. The base station 201 will also receives the handover confirmation signal 42 via the receiving module 300. After this, the handover gateway 204 will repeat the aforementioned operations to complete the confirmation of the base station 203.

After the base station 201 receives the handover confirmation signal 42 via the receiving module 300, the operations of the allocation procedure 218 are completed. Next, the operations of the confirmation procedure 205 are repeated so that each base station can confirm current conditions of all base stations (for example, resource usage, upload and download information and provided services, etc.). Next, since the base station 201 is the main base station, the base station 201 transmits an upload signal 220 and a download signal 221 to the wireless apparatus 200 so that the wireless apparatus 200 can confirm current upload and download information. Finally, after completing the handover operation, services 208, 209 and 210 will be provided by base stations 201, 202 and 203, respectively.

In the first embodiment, if the handover request signal 214 only comprises the information of signal intensities, the base station 201 can actively inform the wireless apparatus 200 via the handover respond signal 216 to perform the handover operation for adjusting the base stations providing services 208, 209 and 210.

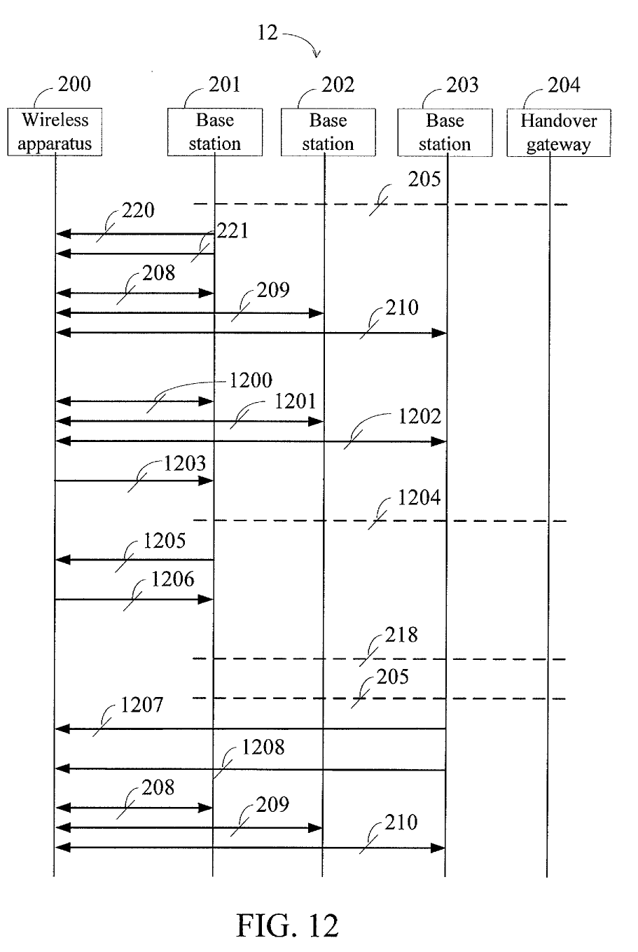

A second embodiment of the invention is shown in FIG. 12 which is a handover system 12 conforming to the WiMAX wireless network specification. The system comprises a wireless apparatus 200, a base station 201, a base station 202, a base station 203 and a handover gateway 204. The second embodiment illustrates an example that a main base station is changed from the base station 201 to the base station 203 via the handover operation. An initial state is that services 208, 209 and 210 are provided by base stations 201, 202 and 203, respectively. The main base station is the base station 201. In the second embodiment, only the different portions as compared to the first embodiment are explained.

At first, the wireless apparatus 200 transmits the measurement signals 1200, 1201 and 1202 to detect signal intensities of the base stations 201, 202 and 203, respectively. The technique for detecting signal intensity is already defined by the WiMAX wireless network specification and thus not repeated here. After obtaining the signal intensity information of each base station, the wireless apparatus 200 can change the base station of providing services according to the signal intensity information of each base station. Consequently, the wireless apparatus 200 transmits a handover request signal 1203 to the base station 201, wherein the handover request signal 1203 comprises the information of wireless network connection intensity, the service bandwidth and the priority of data connection of the wireless apparatus, etc.

The base station 201 receives the handover request signal 1203 via the receiving module 300, wherein the handover request signal 1203 comprises the information of wireless network connection intensity, the service bandwidth and the priority of data connection of the wireless apparatus, etc. Next, the determination module 301 determines whether to accept the request of the handover request signal 1203 according to the resource condition of the handover request signal 1203 and the plurality of base stations. The determination process is the same as the first embodiment and is not repeated here. After determination, the base station 201 transmits the report signal 305 to the handover gateway 204 via the transmission module 303.

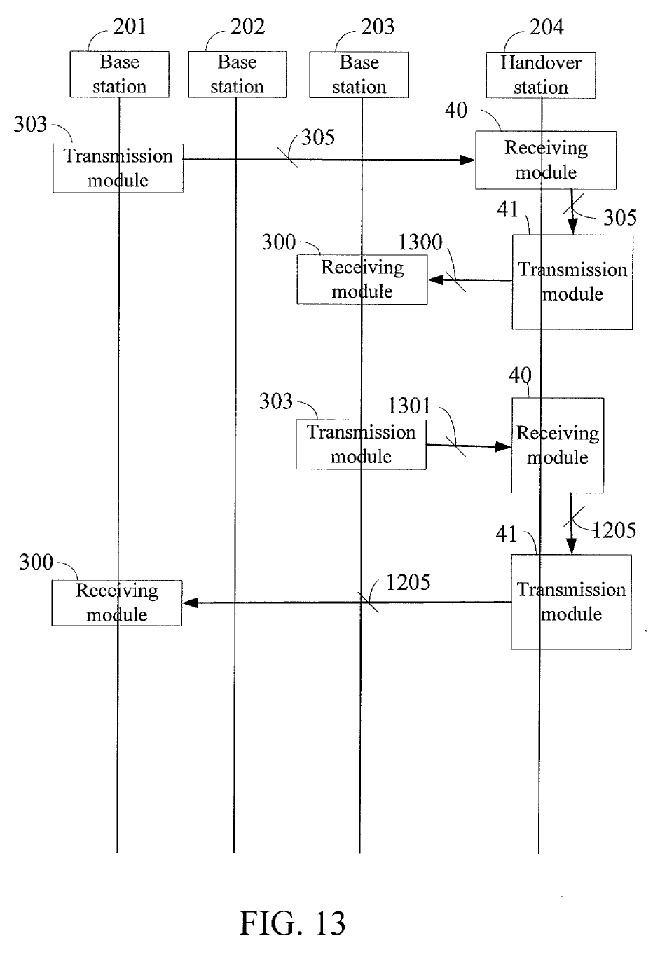

After the base station 201 transmits the report signal 305 via the transmission module 303, the base station 201, the base station 202, the base station 203 and the handover gateway 204 can perform the operations of a reservation procedure 1204 as referred in FIG. 13. The handover gateway 204 receives the report signal 305 via the receiving module 40. The transmission module 41 then transmits a request signal 1300 to the base station 203 according to the report signal 305. The base station 203 receives the request signal 1300 via the receiving module 300 and reserves the required resources for providing the later services according to the request signal 1300. The base station 203 then transmits a confirmation signal 1301 to the handover gateway 204 via the transmission module 303. The handover gateway 204 receives the confirmation signal 1301 via the receiving module 41, wherein the confirmation signal 1301 is used for confirming that the base station 202 reserved the required resources for providing services. Finally, the handover gateway 204 transmits a handover respond signal 1205 to the base station 201 via the transmission module 41. The base station 201 receives the handover respond signal 1205 via the receiving module 300.

Please keep on referring to FIG. 12. After the base station 201 receives the handover respond signal 1205 via the receiving module 300, the base station 201 transmits the handover respond signal 1205 to the wireless apparatus 200 via the transmission module 303. The wireless apparatus 200 will determine whether to accept the allocation of the handover respond signal 1205 and transmit a determination signal 1206 to the base station 201 according to the determination result. The allocation procedure after transmitting the determination signal 1206 to the base station 201 is the same as the first embodiment and is not repeated here.

After the base station 203 becomes the main base station for providing services to the wireless apparatus 200, the base station 203 transmits an upload signal 1207 and a download signal 1208 to the wireless apparatus 200 so that the wireless apparatus 200 can know current upload and download information. Finally, after completing the handover operation, services 208, 209 and 210 will be provided by base stations 201, 202 and 203, respectively, and the main base station is changed from the base station 201 to the base station 203.

In the second embodiment, if the handover request signal 1203 only comprises the information of signal intensities, the base station 201 can actively inform the wireless apparatus 200 via the handover respond signal 1205 to perform the handover operation for changing the main base station.

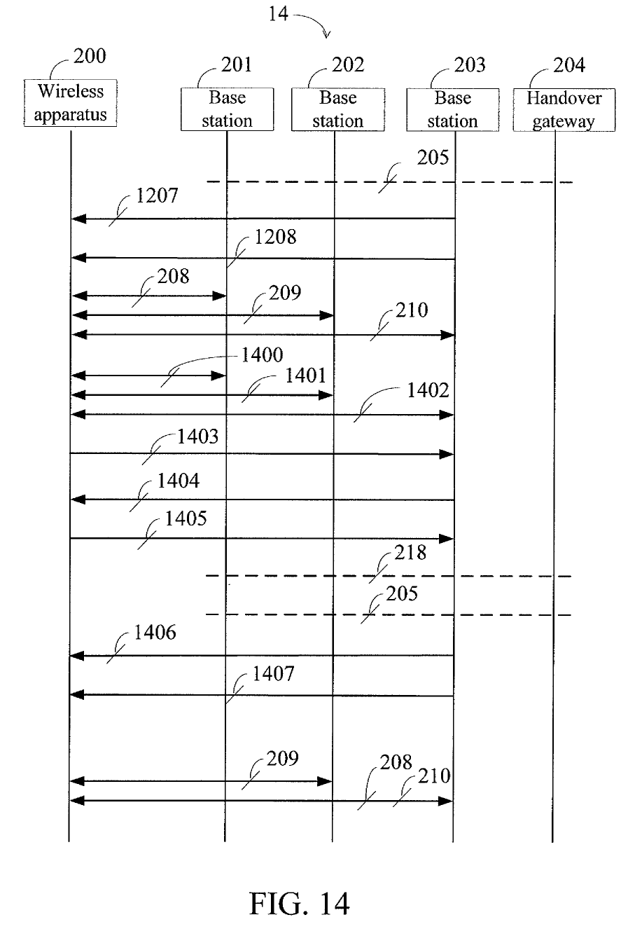

A third embodiment of the invention is shown in FIG. 14 which is a handover system 14 conforming to the WiMAX wireless network specification. The system comprises a wireless apparatus 200, a base station 201, a base station 202, a base station 203 and a handover gateway 204. The third embodiment illustrates an example that the base station 201 is changed to the base station 203 for providing a service 208 via the handover operation. An initial state is that services 208, 209 and 210 are provided by base stations 201, 202 and 203, respectively. The main base station is the base station 201. In the third embodiment, only the different portions as compared to the second embodiment are explained.

Please refer to FIG. 14. At first, the wireless apparatus 200 transmits the measurement signals 1400, 1401 and 1402 to detect signal intensities of the base stations 201, 202 and 203, respectively. The technique for detecting signal intensity is already defined by the WiMAX wireless network specification and thus not repeated here. After obtaining the signal intensity information of each base station, the wireless apparatus 200 can change the base station of providing services according to the signal intensity information of each base station. Consequently, the wireless apparatus 200 transmits a handover request signal 1403 to the base station 203, wherein the handover request signal 1403 comprises the information of wireless network connection intensity, the service bandwidth and the priority of data connection of the wireless apparatus, etc.

The base station 203 receives the handover request signal 1403 via the receiving module 300, wherein the handover request signal 1403 comprises the information of wireless network connection intensity, the service bandwidth and the priority of data connection of the wireless apparatus, etc. Next, the determination module 301 determines whether to accept the request of the handover request signal 1403 according to the resource condition of the handover request signal 1403 and the plurality of base stations. The determination process is the same as the second embodiment and is not repeated here. After determination, the base station 203 transmits a handover respond signal 1404 to the wireless apparatus 200 via the transmission module 303. The wireless apparatus 200 will determine whether to accept the allocation of the handover respond signal 1404 and transmit a determination signal 1405 to the base station 203 according to the determination result. The allocation procedure and the confirmation procedure after transmitting the determination signal 1405 to the base station 203 are the same as the first embodiment and not repeated here.

Next, since the main base station is still the base station 203, the base station 203 transmits an upload signal 1406 and a download signal 1407 to the wireless apparatus 200 so that the wireless apparatus 200 can confirm current upload and download information. Finally, after completing the handover operation, services 208 and 210 are provided by the base station 203, and the service 209 is provided by the base station 202.

In the third embodiment, if the handover request signal 1403 only comprises the information of signal intensities, the base station 203 can actively inform the wireless apparatus 200 via the handover respond signal 1404 to perform the handover operation for adjusting the base stations providing services 208, 209 and 210.

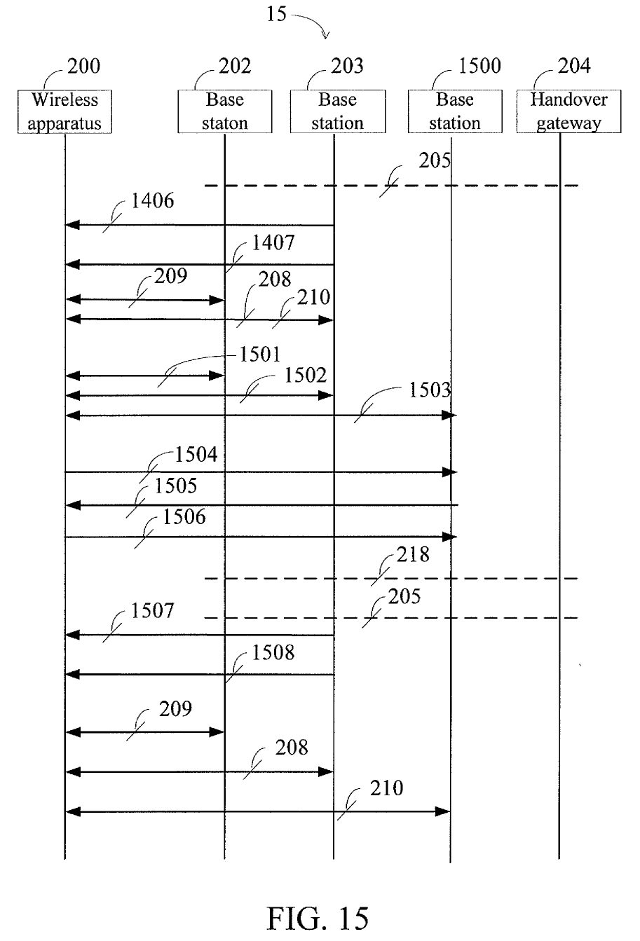

A fourth embodiment of the invention is shown in FIG. 15 which is a handover system 15 conforming to the WiMAX wireless network specification. The system comprises a wireless apparatus 200, a base station 202, a base station 203, a base station 1500 and a handover gateway 204. The fourth embodiment illustrates an example that the base station 203 providing a service 210 is changed to the base station 1500 via the handover operation. An initial state is that services 208 and 210 are provided by the base station 203, and the service 209 is provided by the base station 202. The main base station is the base station 203. In the fourth embodiment, only the different portions as compared to the third embodiment are explained.

The embodiment adds a new base station 1500. Therefore, the operations of the confirmation procedure 205 makes each base station confirm current conditions of each base station as the aforementioned embodiment. The wireless apparatus 200 transmits measurement signals 1501, 1500 and 1503 to detect signal intensities of the base stations 1500, 202 and 203, respectively. The technique for detecting signal intensity is already defined by the WiMAX wireless network specification and thus not repeated here. After obtaining the signal intensity information of each base station, the wireless apparatus 200 can change the base station of providing services according to the signal intensity information of each base station. Consequently, the wireless apparatus 200 transmits a handover request signal 1504 to the base station 203, wherein the handover request signal 1504 comprises the information of wireless network connection intensity, the service bandwidth and the priority of data connection of the wireless apparatus, etc.

After the base station 203 receives the handover request signal 1504, the base station 203 determines whether to accept the request of the handover request signal 1504. The determination method is the same as the third embodiment and is not repeated here. Next, the base station 203 transmits a handover respond signal 1505 to the wireless apparatus 200. The wireless apparatus 200 will determine whether to accept the allocation of the handover respond signal 1505 and transmit a determination signal 1506 to the base station 203 according to the determination result. The allocation procedure and the confirmation procedure after transmitting the determination signal 1506 to the base station 203 are the same as the first embodiment and not repeated here.

Next, the base station 203 transmits an upload signal 1507 and a download signal 1508 to the wireless apparatus 200 so that the wireless apparatus 200 can confirm current upload and download information. Finally, after completing the handover operation, services 208, 209 and 210 are provided by the base stations 203, 202 and 1500, respectively.

In the fourth embodiment, if the handover request signal 1504 only comprises the information of signal intensities, the base station 203 can actively inform the wireless apparatus 200 via the handover respond signal 1505 to perform the handover operation for adjusting the base stations providing services 208, 209 and 210.

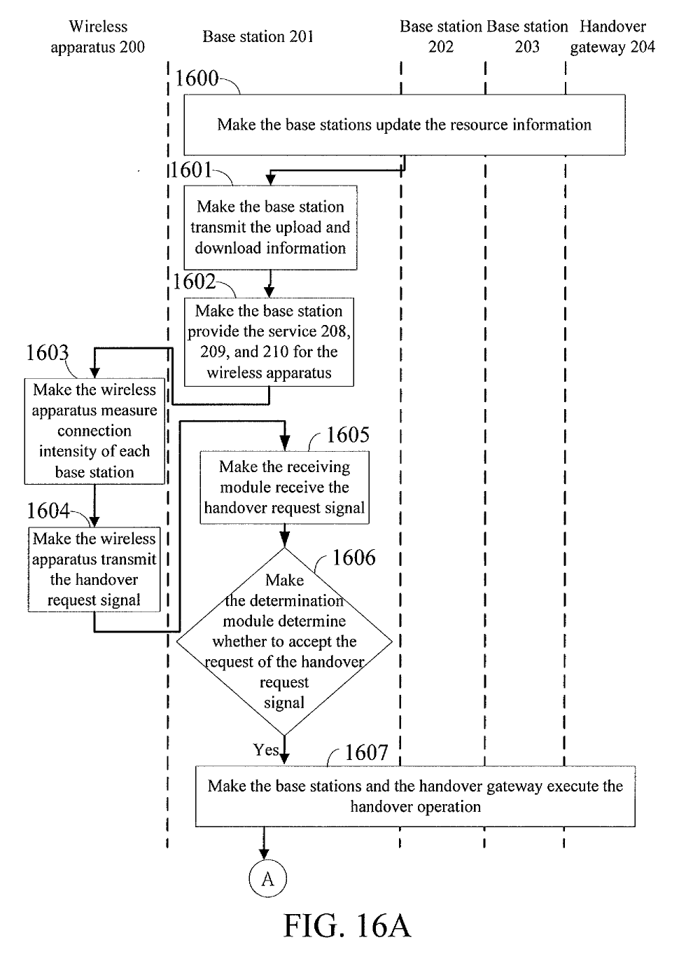

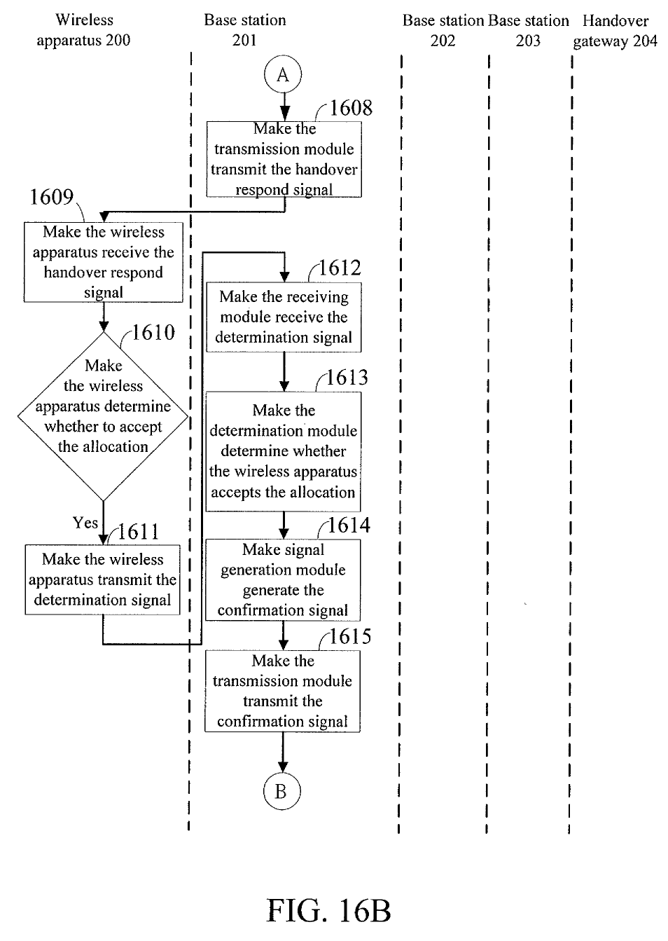

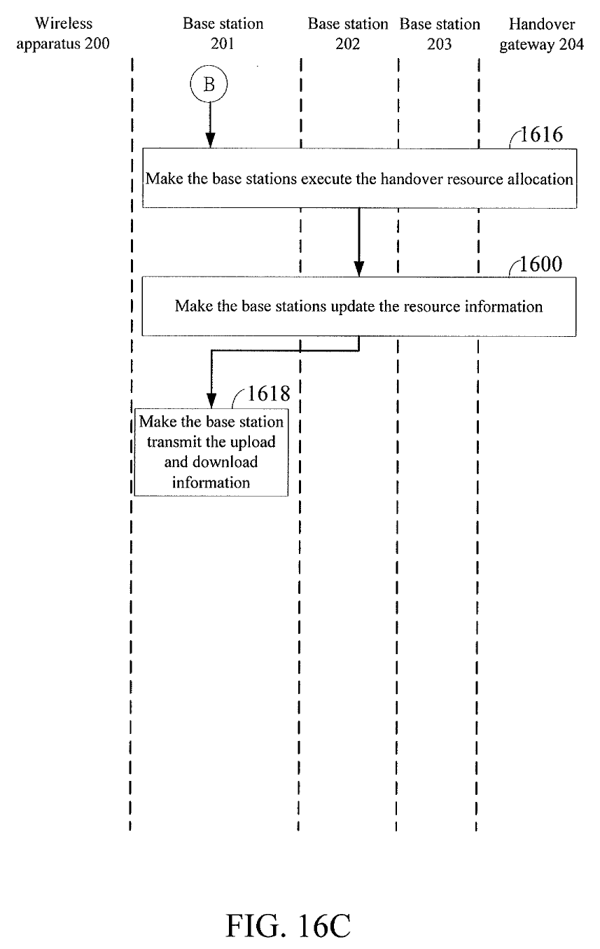

A fifth embodiment of the invention is shown in FIGS. 16A, 16B, 16C and 16D which is a flow chart of a handover control method of a handover system 2 conforming to a WiMAX wireless network specification. The system comprises a wireless apparatus 200, a base station 201, a base station 202, a base station 203 and a handover gateway 204. The following describes the fifth embodiment. Please refer to the descriptions of the handover system 2 of the aforementioned first embodiment together.

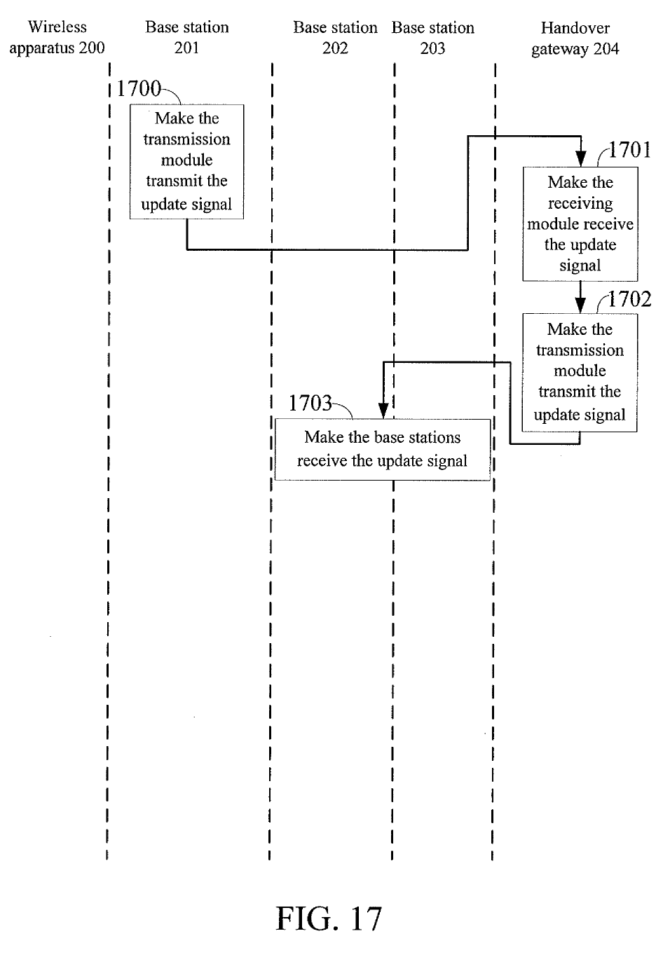

Each of the base stations has to confirm current conditions of each base station (such as resource usage, upload and download information, and provided services, etc.) with each other. At first, step 1600 is executed to enable each of base station update resource information. The detailed steps can be referred to FIG. 17. In FIG. 17, step 1700 is executed to enable the transmission module 303 of the base station 201 transmit an update signal 500 to the handover gateway 204, wherein the update signal 500 comprises the information of current conditions of the base station 201. Step 1701 is executed to enable the handover gateway 204 receive the update signal 500 via the receiving module 40. Step 1702 is executed to enable the transmission module 41 transmit the update signal 500 to the base station 202 and the base station 203, respectively. Step 1703 is executed to enable the base station 202 and the base station 203 receive the update signal 500 via individual receiving module 300. With the aforementioned series of signal transmissions, the base station 202 and the base station 203 can obtain current conditions of the base station 201. Similarly, the base station 202 and the base station 203 will separately transmit the update signal 501 and the update signal 502 to the handover gateway 204. The handover gateway 204 then individually transmits the update signal 501 and the update signal 502 to other base stations. The steps are the same as the base station 201 and thus not repeated here.

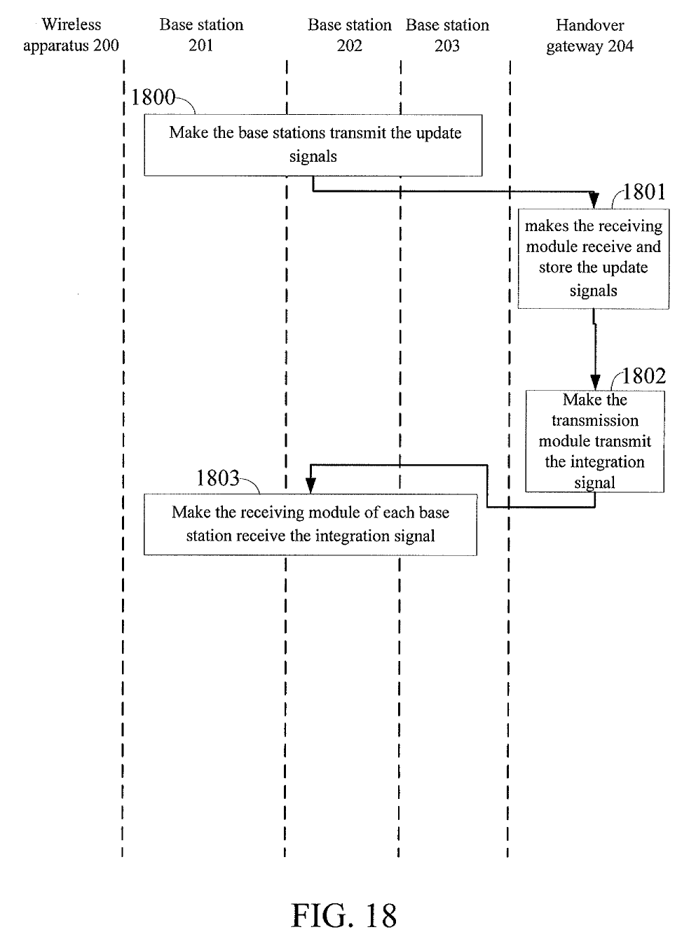

Detailed steps of step 1600 for making each of base station update resource information can also be referred in FIG. 18. At first, step 1800 is executed to enable the base stations 201, 202 and 203 transmit the update signals 500, 501 and 502 to the handover gateway 204 via individual transmission module 303, respectively. Step 1801 is executed to enable the receiving module 40 of the handover gateway 204 individually receives and stores the update signals 500, 501 and 502. Step 1802 is executed to enable the transmission module 41 of the handover gateway 204 transmit an integration signal 600 to the base stations 201, 202 and 203 after a specific period of time. The following step 1803 is executed to enable the receiving module 300 of each base station receive the integration signal 600, wherein the integration signal 600 comprises the information of the stored update signals 500, 501 and 502. With the aforementioned series of signal transmissions, the base stations 201, 202 and 203 can obtain current conditions of each base station.

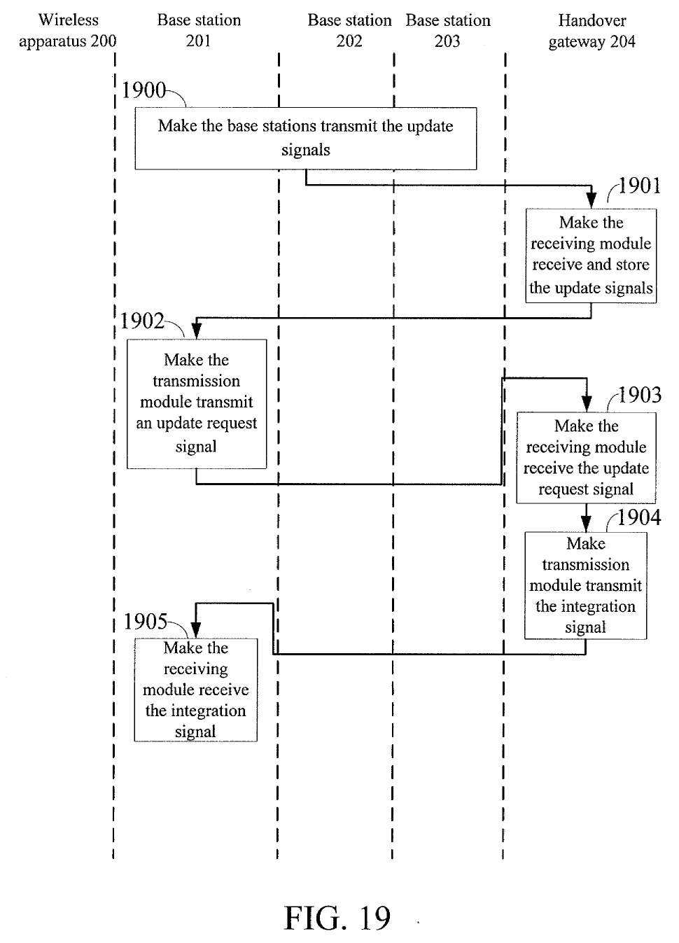

Detailed steps of step 1600 can be further referred in FIG. 19. At first, step 1900 is executed to enable the base stations 201, 202 and 203 transmit the update signals 500, 501 and 502 to the handover gateway 204 via individual transmission module 303, respectively. Step 1901 is executed to enable the receiving module 40 of the handover gateway 204 individually receive and store the update signals 500, 501 and 502. Later, if one base station transmits an update request signal to the handover gateway 204, the handover gateway 204 then transmits the stored conditions of each base station to the base station that transmits the update request signal. For the base station 201 as an example, step 1902 is executed to enable the transmission module 303 of the base station 201 transmit an update request signal 700 to the handover gateway 204. Step 1903 is executed to enable the receiving module 40 of the handover gateway 204 receive the update request signal 700. Step 1904 is executed to enable the transmission module 41 transmit an integration signal 701 to the base station 201, wherein the integration signal 701 comprises the information of the stored update signals 500, 501 and 502. Similarly, the base station 202 and the base station 203 can individually transmit the update signals to the handover gateway 204. The handover gateway 204 then transmits the integration signal 701 to the base station 202 and the base station 203 individually. The steps are the same as the base station 201 and thus not repeated here.

In the fifth embodiment, it is assumed that the base station 201 is a main base station. After completing the aforementioned condition update of each base station, step 1601 is executed to enable the base station 201 transmit an upload signal 206 and a download signal 207 to the wireless apparatus 200, wherein the upload signal 206 comprises all required information related to upload, and the download signal 207 comprises all required information related to download. The wireless apparatus 200 can communicate with the base stations 201, 202 and 203 after it obtains the necessary information. The detailed content of the upload signal 206 and the download signal 207 conforms to the WiMAX wireless specification and is not repeated here.

In the fifth embodiment, three services provided by one base station for one wireless apparatus will be distributed to three different base stations via the handover operation. After executing step 1601, step 1602 is executed to enable the base station 201 provide services 208, 209 and 210 for the wireless apparatus 200. Step 1603 is executed to enable the wireless apparatus 200 transmit the measurement signals 211, 212 and 213 to detect signal intensities of the wireless networks of the base stations 201, 202 and 203, respectively. The technique for detecting signal intensity is already defined by the WiMAX wireless network specification and thus not repeated here. After obtaining the signal intensity information of each base station, the wireless apparatus 200 can change the base station of providing services according to the signal intensity information of each base station. Consequently, step 1604 is executed to enable the wireless apparatus 200 transmit a handover request signal 214 to the base station 201, wherein the handover request signal 214 comprises the information of wireless network connection intensity, the service bandwidth and the priority of data connection of the wireless apparatus, etc.

After the wireless apparatus 200 transmits the handover request signal 214, step 1605 is executed to enable the receiving module 300 of the base station 201 receive the handover request signal 214, wherein the handover request signal 214 comprises the information of wireless network connection intensity, the service bandwidth and the priority of data connection of the wireless apparatus, etc. Next, step 1606 is executed to enable the determination module 301 determine whether to accept the request of the handover request signal 214 according to the resource condition of the handover request signal 214 and the plurality of base stations. If not, the base station 201 maintains current state for providing services. If yes, for example it is assumed that the wireless network connection intensity of the base station 201 is 5 and the remaining resources is 2, the wireless network connection intensity of the base station 202 is 10 and the remaining resources is 5, the wireless network connection intensity of the base station 203 is 15 and the remaining resources is 3; and the resources and priorities required by services 207, 208 and 209 are (6,3), (4,1) and (2,2), respectively. In the fifth embodiment, the smaller priority number represents the higher priority; the larger number of the wireless network connection intensity represents the stronger signal intensity.

At first, the priority ordering is considered to allocate the service 207, the service 208 and the service 209 to the base station 201, the base station 203 and the base station 202 for providing the service, respectively. Next, it is considered that whether the remaining resources of each base station are capable of providing related services. Consequently, the determination module 301 finally allocates the service 207, the service 208 and the service 209 to the base station 201, the base station 202 and the base station 203.

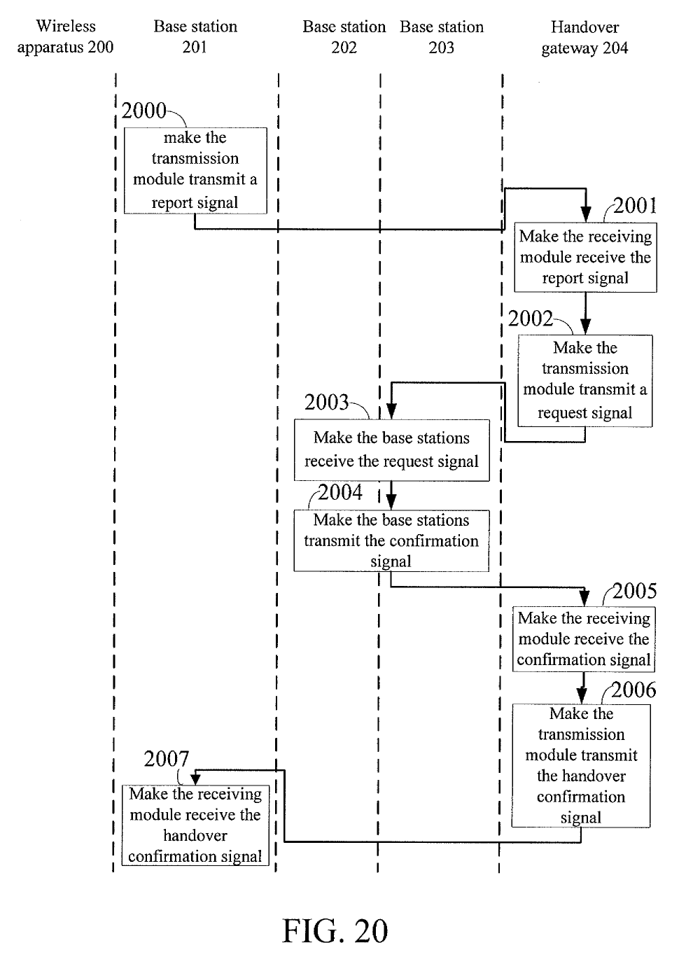

Next, please refer to FIG. 16B. Step 1608 is executed to enable the base station 201, the base station 202, the base station 203 and the handover gateway 204 execute the handover operation. The detailed steps for step 1608 can be referred to FIG. 20. Step 2000 is executed to enable the transmission module 303 of the base station 201 transmit a report signal 305. Step 2001 is executed to enable the receiving module 40 of the handover gateway 204 receive the report signal 305. Next, step 2002 is executed to enable the transmission module 41 transmit a request signal 800 to the base station 202 and the base station 203 according to the report signal 305. Step 2003 is executed to enable the base station 202 and the base station 203 receive the request signal 800 via individual receiving module 300 and reserve the required resources for providing later services according to the request signal 800. Next, step 2004 is executed to enable the base station 202 and the base station 203 respectively transmit a confirmation signal 801 and a confirmation signal 802 to the handover gateway 204 via individual transmission module 303. Step 2005 is executed to enable the receiving module 41 of the handover gateway 204 receive the confirmation signal 801 and the confirmation signal 802, wherein the confirmation signal 801 and the confirmation signal 802 are used for confirming that the base station 202 and the base station 203 reserved the required resources for providing later services. Next, step 2006 is executed to enable the transmission module 41 of the handover gateway 204 transmit a handover respond signal 216 to the base station 201. Finally, step 2007 is executed to enable the receiving module 300 of the base station 201 receive the handover respond signal 216.

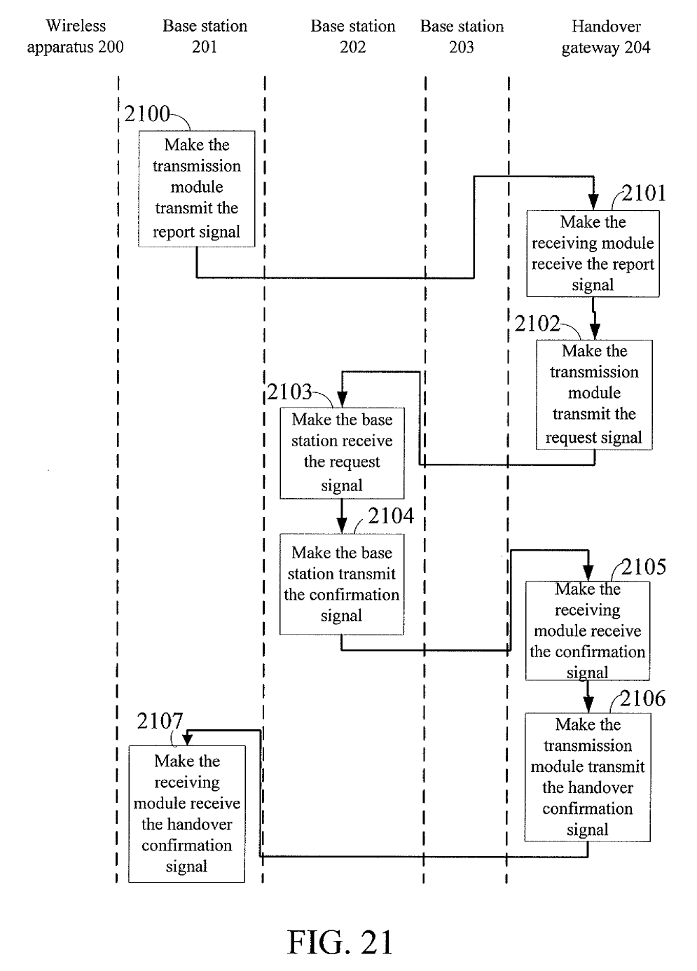

Detailed steps of step 1608 can also be shown in FIG. 21. Wherein step 2100 is executed to enable the transmission module 303 of the base station 201 transmit the report signal 305. Step 2101 is executed to enable the receiving module 40 of the handover gateway 204 receives the report signal 305. Next, step 2102 is executed to enable the transmission module 41 transmit the request signal 800 to the base station 202 according to the report signal 305. Step 2103 is executed to enable the base station 202 receive the request signal 800 via the receiving module 300 and reserve the required resources for providing later services according to the request signal 800. Step 2104 is executed to enable the transmission module 303 of the base station 202 transmit the confirmation signal 801 to the handover gateway 204. Step 2105 is executed to enable the receiving module 40 of the handover gateway 204 receive the confirmation signal 801, wherein the confirmation signal 801 is used for confirming that the base station 202 reserved the required resources for providing later services. Next, step 2106 is executed to enable the transmission module 41 of the handover gateway 204 transmit the handover respond signal 216 to the base station 201. Finally, step 2107 is executed to enable the receiving module 300 of the base station 201 receive the handover respond signal 216.

Please keep on referring to FIG. 16B. Step 1608 is executed to enable the transmission module 303 of the base station 201 transmit the handover respond signal 216 to the wireless apparatus 200. Step 1609 is executed to enable the wireless apparatus 200 receive the handover respond signal 216. Next, step 1610 is executed to enable the wireless apparatus 200 determine whether to accept the allocation of the handover respond signal 216. Next, step 1611 is executed to enable the wireless apparatus 200 transmit a determination signal 217 to the base station 201 according to the determination result.

Next, step 1612 is executed to enable the receiving module of the base station 201 receive the determination signal 217. Step 1613 is executed to enable the determination module determine whether the wireless apparatus 200 accepts the allocation of the handover respond signal 216. If not, the base station 201 does not change current state of servicing and continues to provide services 208, 209 and 210. If yes, step 1614 is executed to enable the signal generation module 302 generate a first confirmation signal 307. Next, step 1615 make the transmission module 303 of the base station 201 transmit the first confirmation signal 307 to the handover gateway 204.

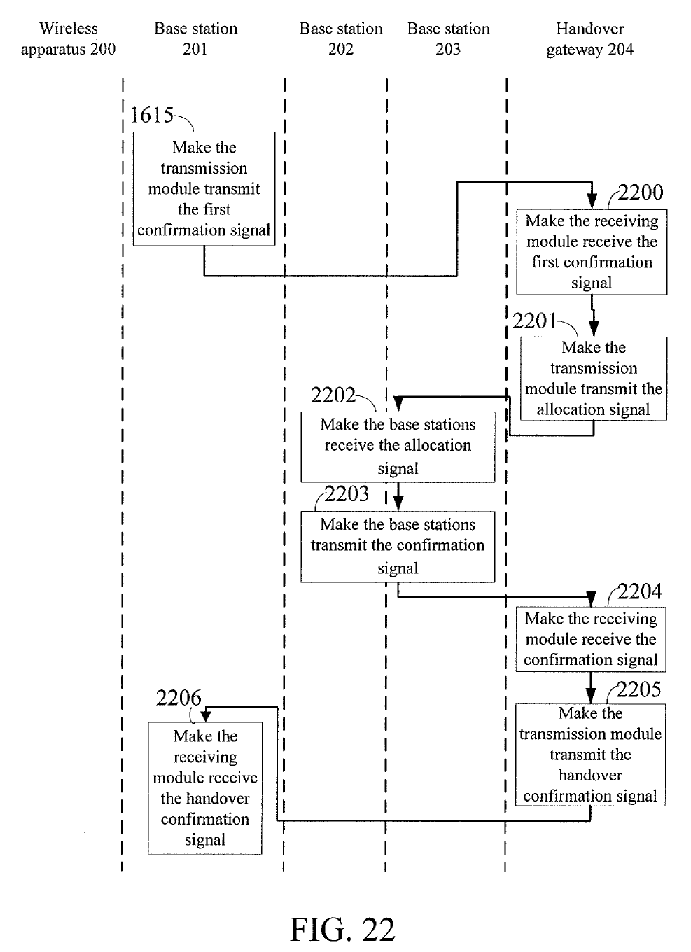

Please refer to FIG. 16C. Step 1616 is executed to enable the base station 201, the base station 202, the base station 203, and the handover gateway 204 execute a handover resource allocation. Detailed steps of step 1616 can be referred in FIG. 22. Wherein step 2200 is executed to enable the receiving module 40 of the handover gateway 204 receive the first confirmation signal 307. Next, step 2201 is executed to enable the transmission module 41 transmit an allocation signal 1000 to the base station 202 and the base station 203 according to the first confirmation signal 307. Step 2202 is executed to enable the base station 202 and the base station 203 receive the allocation signal 1000 via individual receiving module 300 and allocate the required resources for providing services according to the allocation signal 1000. Next, step 2203 is executed to enable the base station 202 and the base station 203 respectively transmit a confirmation signal 1001 and a confirmation signal 1002 to the handover gateway 204 via individual transmission module 303. Step 2204 is executed to enable the receiving module 40 of the handover gateway 204 receive the confirmation signal 1001 and the confirmation signal 1002, wherein the confirmation signal 1001 and the confirmation signal 1002 are used for confirming that the base station 202 and the base station 203 allocated the reserved resources required for providing services. Finally, step 2205 is executed to enable the transmission module 41 of the handover gateway 204 transmit a handover confirmation signal 42 to the base station 201. Step 2206 is executed to enable the receiving module 308 of the base station 201 receive the handover confirmation signal 42.

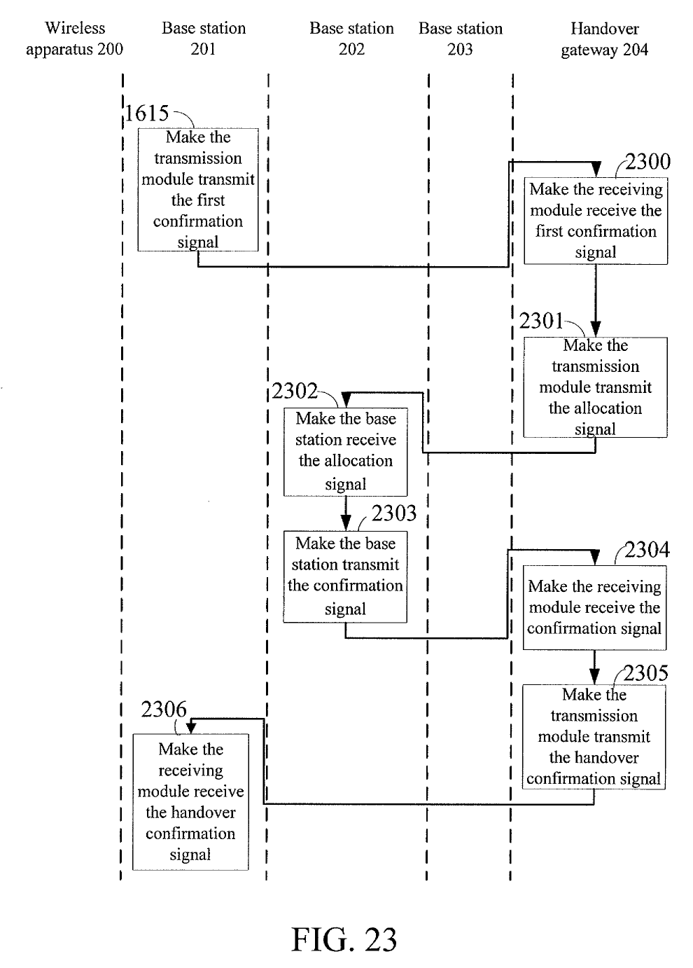

Detailed steps of step 1616 can also be the same steps shown in FIG. 23. Wherein step 2300 is executed to enable the receiving module 40 of the handover gateway 204 receive the first confirmation signal 307. Next, step 2301 is executed to enable the transmission module 41 transmit the allocation signal 1000 to the base station 202 according to the first confirmation signal 307. Step 2302 is executed to enable the receiving module 300 of the base station 202 receive the allocation signal 1000 and allocate the reserved sources required for providing services according to the allocation signal 1000. Next, step 2303 is executed to enable the transmission module 303 of the base station 202 transmit the confirmation signal 1001 to the handover gateway 204. Step 2304 is executed to enable the receiving module 40 of the handover gateway 204 receive the confirmation signal 1001, wherein the confirmation signal 1001 is used for confirming that the base station 202 allocated the reserved resources required for proving services. Finally, step 2305 is executed to enable the transmission module 41 of the handover gateway 204 transmit the handover confirmation signal 42 to the base station 201. Step 2306 is executed to enable the receiving module 300 of the base station 201 receive the handover confirmation signal 42.

After step 2206 is executed to enable the receiving module 300 of the base station 201 receive the handover confirmation signal 42, it means that the handover operation is completed. Next, the operations of step 1600 are repeated so that each base station can confirm current conditions of all base stations (for example, resource usage, upload and download information and provided services, etc.). Next, since the base station 201 is still the main base station, step 1618 is executed to enable the base station 201 transmit an upload signal 220 and a download signal 221 to the wireless apparatus 200 so that the wireless apparatus 200 can confirm current upload and download information. Finally, after completing the handover operation, services 208, 209 and 210 will be provided by base stations 201, 202 and 203, respectively.

In the fifth embodiment, if the handover request signal 214 only comprises the information of signal intensities, the base station 201 can actively inform the wireless apparatus 200 via the handover respond signal 216 to perform the handover operation for adjusting the base stations providing services 208, 209 and 210.

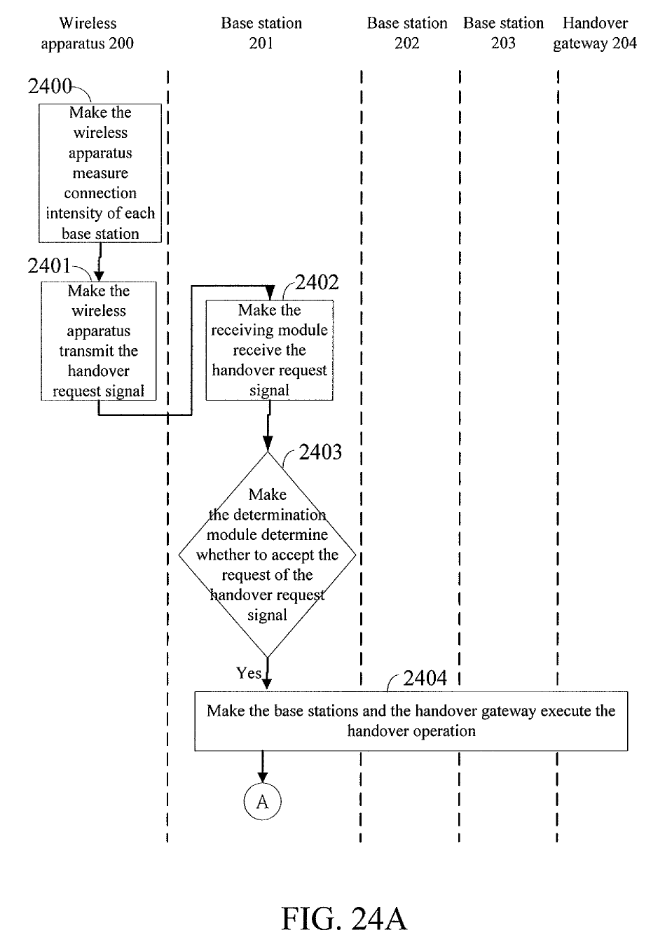

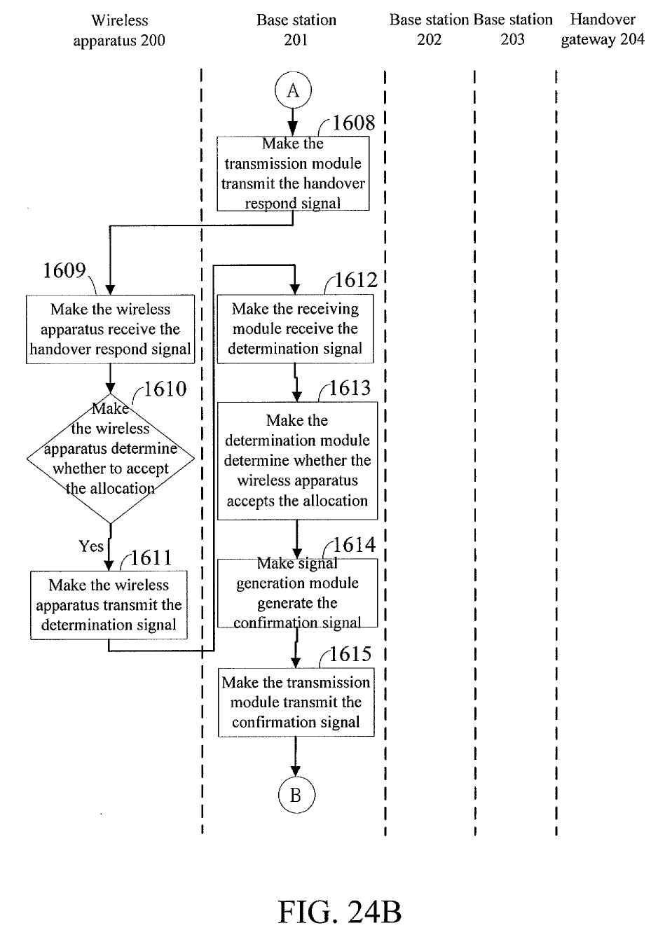

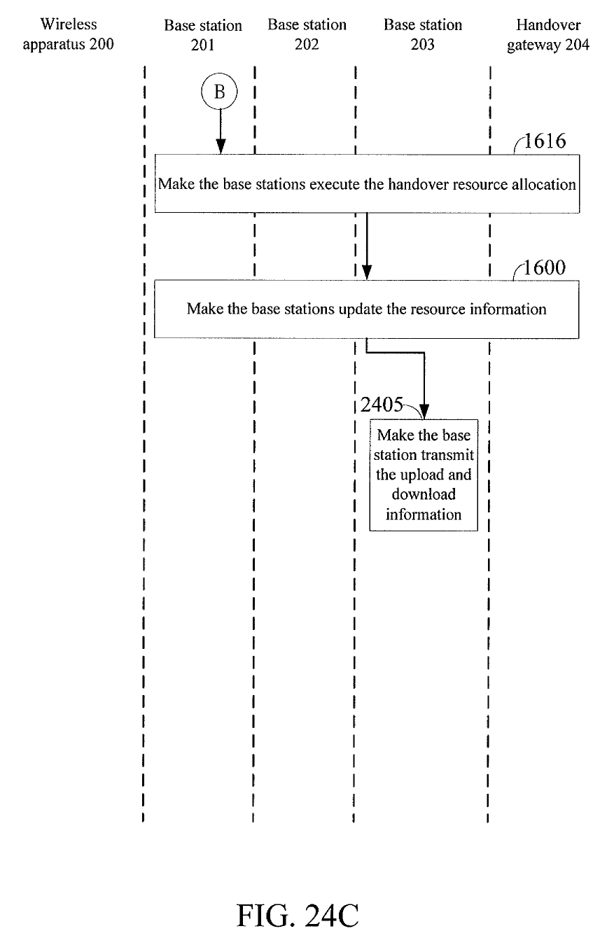

A sixth embodiment of the invention is shown in FIGS. 24A, 24B and 24C, which is a flow chart of a handover control method of a handover system 12 conforming to the WiMAX wireless network specification. The system comprises a wireless apparatus 200, a base station 201, a base station 202, a base station 203 and a handover gateway 204. The sixth embodiment illustrates an example that a main base station is changed from the base station 201 to the base station 203 via the handover operation. An initial state is that services 208, 209 and 210 are provided by base stations 201, 202 and 203, respectively. The main base station is the base station 201. In the sixth embodiment, only the different portions as compared to the fifth embodiment are explained. Please also refer to the descriptions of the handover system 12 of aforementioned second embodiment for the following descriptions about the sixth embodiment.

Step 2400 is executed to enable the wireless apparatus 200 transmit the measurement signals 1200, 1201 and 1202 to detect signal intensities of the base stations 201, 202 and 203, respectively. The technique for detecting signal intensity is already defined by the WiMAX wireless network specification and thus not repeated here. After obtaining the signal intensity information of each base station, the wireless apparatus 200 can change the base station of providing services according to the signal intensity information of each base station. Consequently, step 2401 is executed to enable the wireless apparatus 200 transmit a handover request signal 1203 to the base station 201, wherein the handover request signal 1203 comprises the information of wireless network connection intensity, the service bandwidth and the priority of data connection of the wireless apparatus, etc.

Step 2402 is executed to enable the receiving module 300 of the base station 201 receive the handover request signal 1203, wherein the handover request signal 1203 comprises the information of wireless network connection intensity, the service bandwidth and the priority of data connection of the wireless apparatus, etc. Next, step 2403 is executed to enable the determination module 301 determine whether to accept the request of the handover request signal 1203 according to the resource condition of the handover request signal 1203 and the base stations. The determination operation is the same as the fifth embodiment and is not repeated here.

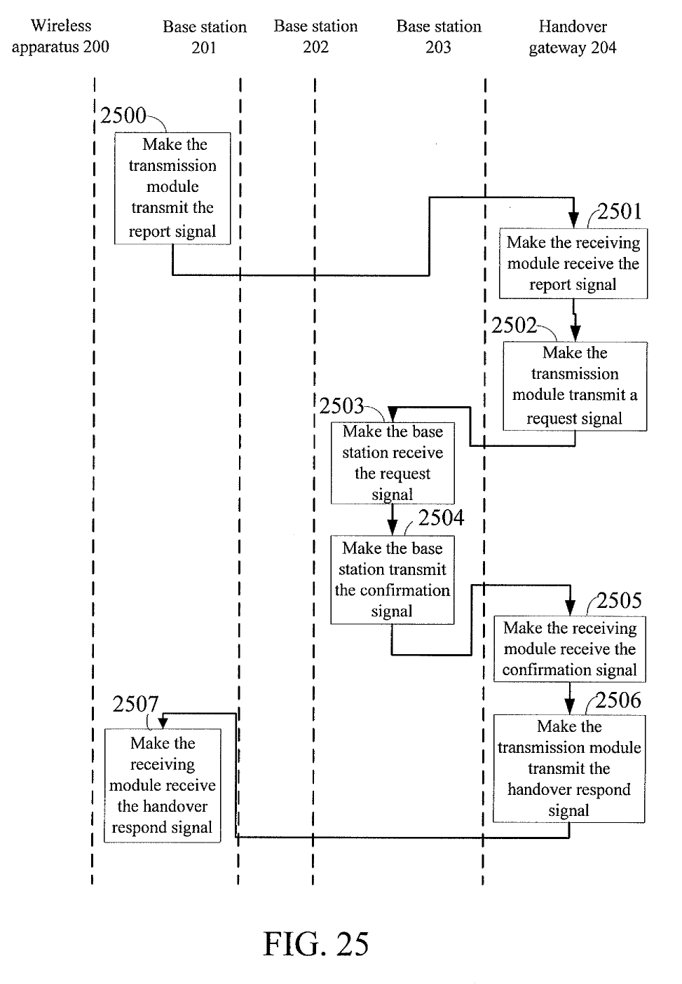

Next, detailed steps of the step 2404 can be referred to FIG. 25. After step 2500 is executed to enable the transmission module 303 of the base station 201 transmit the report signal 305, step 2501 is executed to enable the receiving module 40 of the handover gateway 204 receive the report signal 305. Next, step 2502 is executed to enable the transmission module 41 transmit a request signal 1300 to the base station 203 according to the report signal 305. Step 2503 is executed to enable the receiving module 300 of the base station 203 receive the request signal 1300 and reserve the required resources for providing later services according to the request signal 1300. Next, step 2504 is executed to enable the transmission module 303 of the base station 203 transmit a confirmation signal 1301 to the handover gateway 204. Step 2505 is executed to enable the receiving module 41 of the handover gateway 204 receive the confirmation signal 1301, wherein the confirmation signal 1301 is used for confirming that the base station 202 reserved the required resources for providing later services. Finally, step 2506 is executed to enable the transmission module 41 of the handover gateway 204 transmit a handover respond signal 1205 to the base station 201. Step 2507 is executed to enable the receiving module 300 of the base station 201 receive the handover respond signal 1205.

Executed steps after step 2404 of the sixth embodiment are shown in FIG. 24B and FIG. 24C, and are similar to most of steps executed after step 1607 of the fifth embodiment with only a difference for the last step so that no unnecessary detail is given here. Finally, after the base station 203 becomes the main base station, step 2405 is executed to enable the base station 203 transmit an upload signal 1207 and a download signal 1208 to the wireless apparatus 200 so that the wireless apparatus 200 can confirm current upload and download information. Finally, after completing the handover operation, services 208, 209 and 210 will be provided by base stations 201, 202 and 203, respectively. The main base station is changed from the base station 201 to the base station 203.

In the sixth embodiment, if the handover request signal 1203 only comprises the information of signal intensities, the base station 201 can actively inform the wireless apparatus 200 via the handover respond signal 1205 to perform the handover operation for changing the main base station.

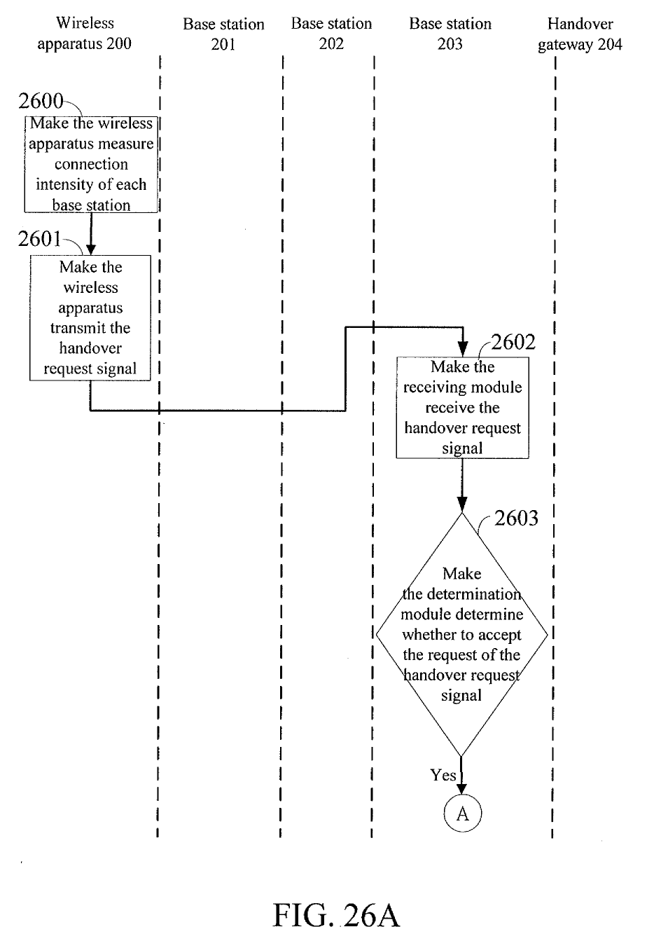

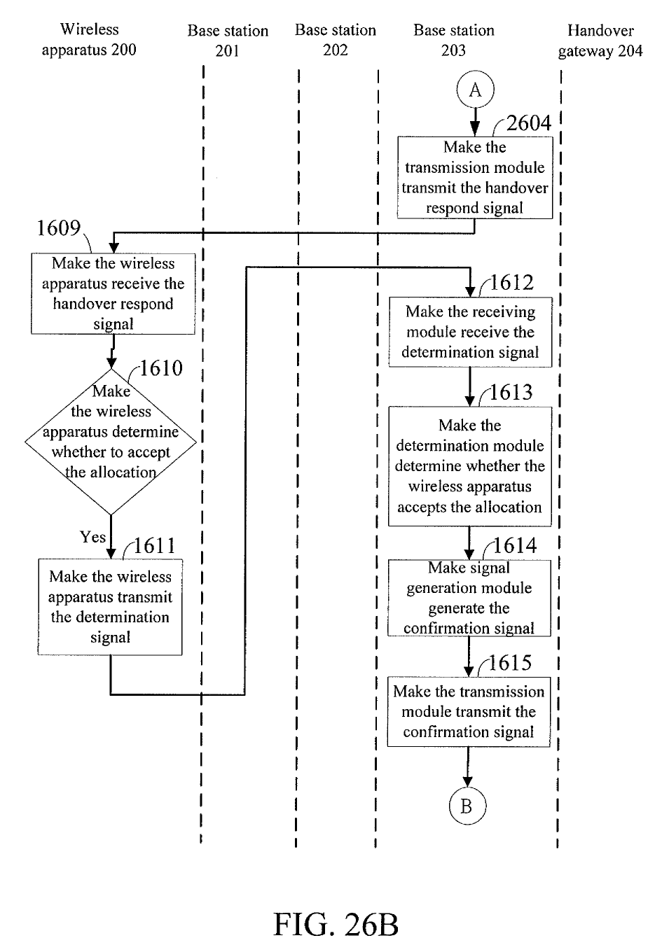

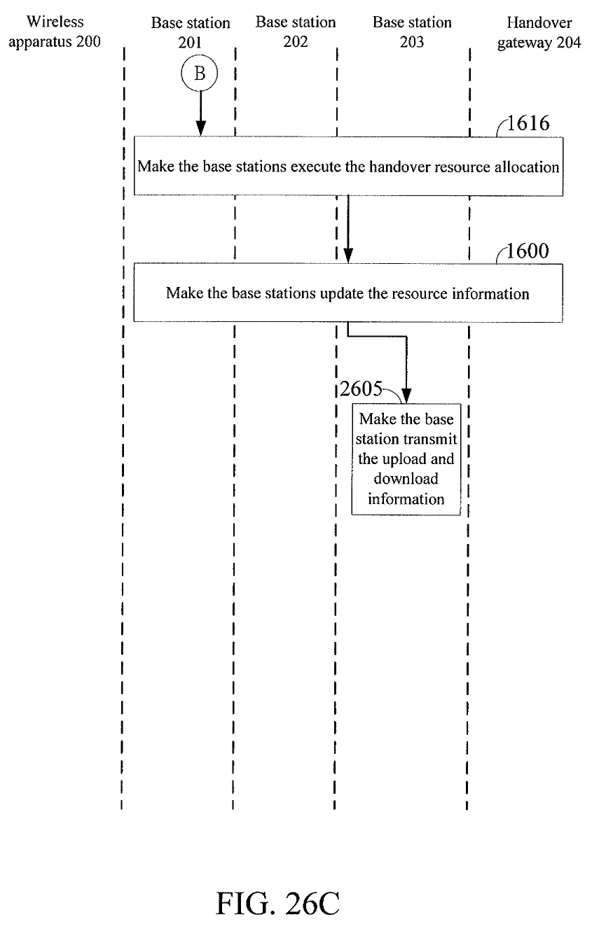

A seventh embodiment of the invention is shown in FIG. 26A, 26B and 26C, which is a flow chart of a handover control method of a handover system 14 conforming to the WiMAX wireless network specification. The system comprises a wireless apparatus 200, a base station 201, a base station 202, a base station 203 and a handover gateway 204. The seventh embodiment illustrates an example that the base station 201 is changed to the base station 203 for providing a service 208 via the handover operation. An initial state is that services 208, 209 and 210 are provided by base stations 201, 202 and 203, respectively. The main base station is the base station 201. In the seventh embodiment, only the different portions as compared to the sixth embodiment are explained. Please also refer to the descriptions of the handover system 14 of aforementioned third embodiment for the following descriptions about the seventh embodiment.

Please refer to FIG. 26A. Step 2600 is executed to enable the wireless apparatus 200 transmit the measurement signals 1400, 1401 and 1402 to detect signal intensities of the base stations 201, 202 and 203, respectively. The technique for detecting signal intensity is already defined by the WiMAX wireless network specification and thus not repeated here. After obtaining the signal intensity information of each base station, step 2601 is executed to enable the wireless apparatus 200 change the base station of providing services according to the signal intensity information of each base station. Consequently, the wireless apparatus 200 transmits a handover request signal 1403 to the base station 203, wherein the handover request signal 1403 comprises << the information of wireless network connection intensity, the service bandwidth and the priority of data connection of the wireless apparatus, etc.

Next, step 2602 is executed to enable the receiving module 300 of the base station 203 receive the handover request signal 1403, wherein the handover request signal 1403 comprises the information of wireless network connection intensity, the service bandwidth and the priority of data connection of the wireless apparatus, etc. Next, step 2603 is executed to enable the determination module 301 determine whether to accept the request of the handover request signal 1403 according to the resource condition of the handover request signal 1403 and the base stations. The determination process is the same as the sixth embodiment and is not repeated here.

Please refer to FIG. 26B. After determination, step 2604 is executed to enable the transmission module 303 of the base station 203 transmit a handover respond signal 1404 to the wireless apparatus 200. Steps after step 2604 are the same as steps after step 1604 of the sixth embodiment and thus no unnecessary detail is given here.

Please refer to FIG. 26C. Next, since the main base station is still the base station 203, step 2605 is executed to enable the base station 203 transmit an upload signal 1406 and a download signal 1407 to the wireless apparatus 200 so that the wireless apparatus 200 can confirm current upload and download information. Finally, after completing the handover operation, services 208 and 210 are provided by the base station 203, and the service 209 is provided by the base station 202.

In the seventh embodiment, if the handover request signal 1403 only comprises the information of signal intensities, the base station 203 can actively inform the wireless apparatus 200 via the handover respond signal 1404 to perform the handover operation for adjusting the base stations providing services 208, 209 and 210.

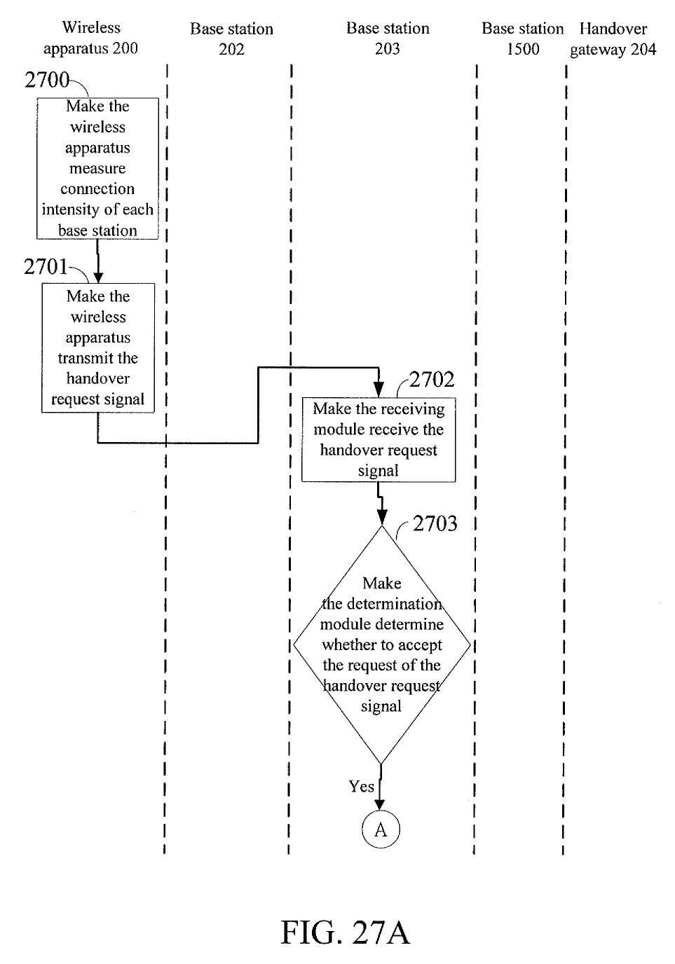

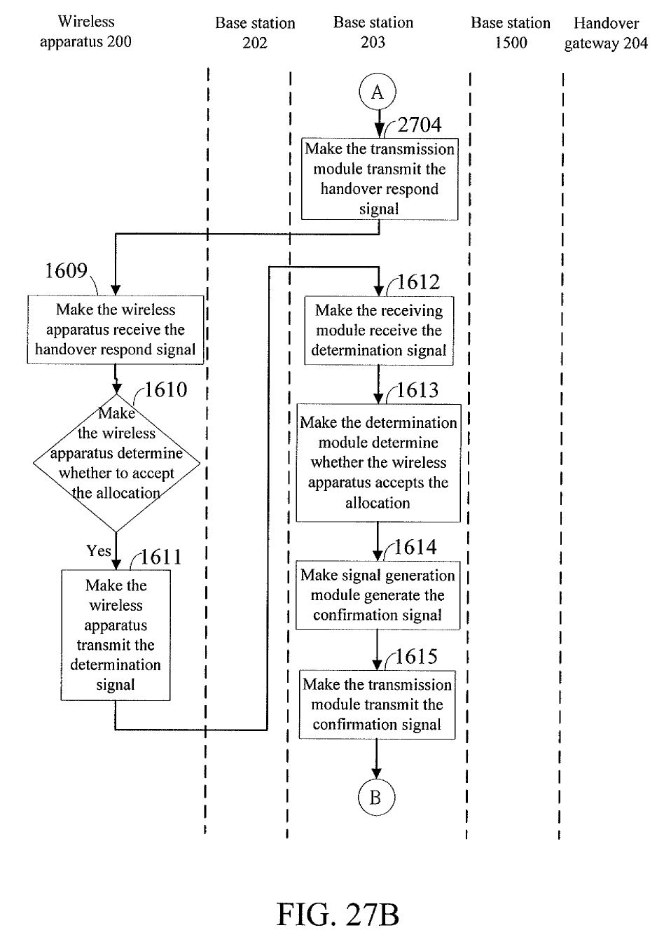

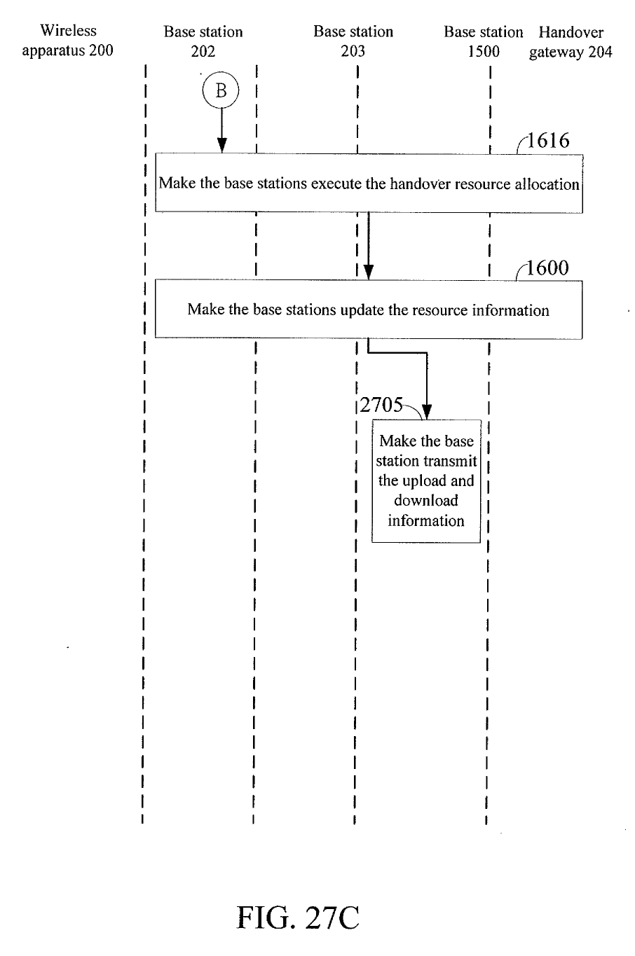

An eighth embodiment of the invention is shown in FIG. 27A, 27B and 27C, which is a flow chart of a handover control method of a handover system 15 conforming to the WiMAX wireless network specification. The system comprises a wireless apparatus 200, a base station 202, a base station 203, a base station 1500 and a handover gateway 204. The eighth embodiment illustrates an example that the base station 203 providing a service 210 is changed to the base station 1500 via the handover operation. An initial state is that services 208 and 210 are provided by the base station 203, and the service 209 is provided by the base station 202. The main base station is the base station 203. In the eighth embodiment, only the different portions as compared to the seventh embodiment are explained. Please also refer to the descriptions of the handover system 15 of aforementioned fourth embodiment for the following descriptions of the eighth embodiment.

In this embodiment, a new base station 1500 is added. As same as the fifth embodiment, the operations of step 1600 make each base station confirm current conditions of each base station as the aforementioned embodiment. Please refer to FIG. 27A. Step 2700 is executed to enable the wireless apparatus 200 transmit the measurement signals 1501, 1500 and 1503 to detect signal intensities of the base stations 1500, 202 and 203, respectively. The technique for detecting signal intensity is already defined by the WiMAX wireless network specification and thus not repeated here. After obtaining signal intensity information of each base station, the wireless apparatus 200 can change the base station of providing services according to the signal intensity information of each base station. Consequently, step 2701 is executed to enable the wireless apparatus 200 transmit a handover request signal 1504 to the base station 203, wherein the handover request signal 1504 comprises the information of wireless network connection intensity, the service bandwidth and the priority of data connection of the wireless apparatus, etc.

After step 2702 is executed to enable the receiving module 300 of the base station 203 receive the handover request signal 1504, step 2703 is executed to enable the base station 203 determine whether to accept the request of the handover request signal 1504. The determination method is the same as the seventh embodiment and is not repeated here.

Please refer to FIG. 27B. After determination, step 2704 is executed to enable the transmission module 303 of the base station 203 transmit a handover respond signal 1505 to the wireless apparatus 200. Steps after step 2704 are the same as steps after step 1608 of the sixth embodiment and thus no unnecessary detail is given here.

Please refer to FIG. 27C. Step 2705 is executed to enable the base station 203 transmit an upload signal 1507 and a download signal 1508 to the wireless apparatus 200 so that the wireless apparatus 200 can confirm current upload and download information. Finally, after completing the handover operation, services 208, 209 and 210 are provided by the base stations 203, 202 and 1500, respectively.

In the eighth embodiment, if the handover request signal 1504 only comprises the information of signal intensities, the base station 203 can actively inform the wireless apparatus 200 via the handover respond signal 1505 to perform the handover operation for adjusting the base stations providing services 208, 209 and 210.

Each of the aforementioned methods can use a computer readable medium for storing a computer program to execute the aforementioned steps. The computer readable medium can be a floppy disk, a hard disk, an optical disc, a flash disk, a tape, a database accessible from a network or a storage medium with the same functionality that can be easily thought by people skilled in the art.

The invention can dynamically decide the base stations which provide the services so that if the services of the wireless apparatus can be provide by the base station with better signal. If no base station can provide all services of the wireless apparatus, the invention can reserve the services with higher priority to be provided by the base station depending on the priority of each service. Consequently, the invention enables the resource of each base station to be utilized effectively and ensures the service quality of services of the wireless apparatus. And the services required by users can be kept without being interrupted to further enhance an overall performance of the wireless services.

The above disclosure is related to the detailed technical contents and inventive features thereof People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A handover method of a wireless network, comprising steps of:
receiving a report signal from a first base station;
transmitting a handover respond signal to the first base station according to the report signal;
receiving a first confirmation signal from the first base station; and
transmitting a handover confirmation signal to the first base station according to the first confirmation signal;
wherein the first base station is one of a plurality of base stations providing a wireless apparatus with the wireless network services.

2. The handover method of claim 1, further comprising steps of:
receiving a update signal from the first base station; and
transmitting the update signal to the base stations except the first base station.

3. The handover method of claim 1, further comprising steps of:
receiving update signals from each of the base stations; and
transmitting the update signals to the base stations after a specific period of time.

4. The handover method of claim 1, further comprising steps of.
receiving update signals from each of the base stations; and
determining whether the first base station requests to obtain the update signal from each of the base stations; and
transmitting the update signal from each of the base stations to the first base station according the determination result.

5. The handover method of claim 1, wherein the step of transmitting a handover respond signal comprises the steps of:
transmitting a request signal to a second base station according to the report signal;
receiving a confirmation signal form the second base station; and
transmitting the handover respond signal to the first base station according to the confirmation signal;
wherein the second base station is one of the base stations.

6. The handover method of claim 1, wherein the step of transmitting a handover respond signal comprises the steps of:
transmitting a request signal to at least one of the base stations according to the report signal;
receiving at least one confirmation signal form the base stations which receive the request signal; and
transmitting the handover respond signal to the first base station according to the confirmation signals.

7. The handover method of claim 1, wherein the step of transmitting a handover confirmation signal comprises the steps of:
transmitting an allocation signal to the base stations for allocating the service resource of wireless network according to the first confirmation signal;
receiving a plurality of confirmation signals from the base stations; and
transmitting the handover confirmation signal to the first base station according to the confirmation signals.

8. The handover method of claim 1, wherein the step of transmitting a handover confirmation signal comprises the steps of:
transmitting an allocation signal to a second base station for allocating the service resource of wireless network according to the first confirmation signal;
receiving a confirmation signal from the second base station; and
transmitting the handover confirmation signal to the first base station according to the confirmation signal.

9. A handover apparatus of a wireless network, comprising:
a receiving module for receiving a report signal and a first confirmation signal from a first base station; and
a transmission module for transmitting a handover respond signal to the first base station according to the report signal and transmitting a handover confirmation signal to the first base station according to the first confirmation signal;
wherein the first base station is one of a plurality of base stations providing a wireless apparatus with the wireless network services.

10. The handover apparatus of claim 9, wherein the receiving module receives an update signal from the first base station, and the transmitting module transmits the update signal to the base stations except the first base station.

11. The handover apparatus of claim 9, wherein the receiving module receives update signals from each of the base stations, and the transmitting module transmits the update signals to the base stations after a specific period of time.

12. The handover apparatus of claim 9, further comprising a determination module for determining whether the first base station requests to obtain update signals from each of the base stations.

13. The handover apparatus of claim 12, wherein the receiving module receives the update signal from each of the base stations, and the transmitting module transmits the update signal from each of the base stations to the first base station according the determination result.

14. The handover apparatus of claim 9, wherein the transmission module transmits a request signal to a second base station according to the report signal, the receiving module receives a confirmation signal from the second base station, transmission module transmits the handover respond signal to the first base station according to the confirmation signal, and the second base station is one of the base stations.

15. The handover apparatus of claim 9, wherein the transmission module transmits a request signal to at least one of the base stations according to the report signal, the receiving module receives at least one confirmation signal form the base stations which receive the request signal, and transmission module transmits the handover respond signal to the first base station according to the confirmation signals.

16. The handover apparatus of claim 9, wherein the transmission module transmits an allocation signal to the base stations for allocating the service resource of wireless network according to the first confirmation signal, the receiving module receives a plurality of confirmation signals from the base stations, and the transmission module transmits the handover confirmation signal to the first base station according to the confirmation signals.

17. The handover apparatus of claim 9, wherein the transmission module transmits an allocation signal to a second base station for allocating the service resource of wireless network according to the first confirmation signal, the receiving module receives a confirmation signal from the second base station, and the transmission module transmits the handover confirmation signal to the first base station according to the confirmation signal.

18. A computer readable medium storing a computer program to execute a handover method of a wireless network, the handover method comprising steps of:
receiving a report signal from a first base station;
transmitting a handover respond signal to the first base station according to the report signal;
receiving a first confirmation signal from the first base station; and
transmitting a handover confirmation signal to the first base station according to the first confirmation signal;
wherein the first base station is one of a plurality of base stations providing a wireless apparatus with the wireless network services.

19. The computer readable medium of claim 18, further comprising steps of:
receiving a update signal from the first base station; and
transmitting the update signal to the base stations except the first base station.

20. The computer readable medium of claim 18,the method further comprising steps of:
receiving update signals from each of the base stations; and
transmitting the update signals to the base stations after a specific period of time.

21. The computer readable medium of claim 18, the method further comprising steps of:
receiving update signals from each of the base stations; and
determining whether the first base station requests to obtain the update signal from each of the base stations; and
transmitting the update signal from each of the base stations to the first base station according the determination result.

22. The computer readable medium of claim 18, wherein the step of transmitting a handover respond signal comprises the steps of:
transmitting a request signal to a second base station according to the report signal;
receiving a confirmation signal form the second base station; and
transmitting the handover respond signal to the first base station according to the confirmation signal;
wherein the second base station is one of the base stations.

23. The computer readable medium of claim 18, wherein the step of transmitting a handover respond signal comprises the steps of:
transmitting a request signal to at least one of the base stations according to the report signal;
receiving at least one confirmation signal form the base stations which receive the request signal; and
transmitting the handover respond signal to the first base station according to the confirmation signals.

24. The computer readable medium of claim 18, wherein the step of transmitting a handover confirmation signal comprises the steps of:
transmitting an allocation signal to the base stations for allocating the service resource of wireless network according to the first confirmation signal;
receiving a plurality of confirmation signals from the base stations; and
transmitting the handover confirmation signal to the first base station according to the confirmation signals.

25. The computer readable medium of claim 18, wherein the step of transmitting a handover confirmation signal comprises the steps of:
transmitting an allocation signal to a second base station for allocating the service resource of wireless network according to the first confirmation signal;
receiving a confirmation signal from the second base station; and
transmitting the handover confirmation signal to the first base station according to the confirmation signal.

26. A handover control method of a wireless network, comprising steps of:
receiving a handover request signal from a wireless apparatus;
transmitting a report signal to a handover gateway according to the handover request signal;
receiving a handover respond signal from the handover gateway;
transmitting the handover respond signal to the wireless apparatus;
receiving a determination signal from the wireless apparatus;
transmitting a confirmation signal to the handover gateway according to the determination;
receiving an allocation signal from the handover gateway; and
allocating the service resource according to the allocation signal.

27. The handover control method of claim 26, further comprising the steps of:
determining whether the handover request signal is accepted according to the handover request signal and the linking resource statuses of a plurality of base stations; and
generating the report signal according to the determination result.

28. The handover control method of claim 26, further comprising the steps of:
determining whether the wireless apparatus accepts the decision of the handover respond signal according to the determination signal; and
generating the confirmation signal according to the determination result.

29. A handover control apparatus of a wireless network, comprising:
a receiving module for receiving a handover request signal and a determination signal from a wireless apparatus, and a handover respond signal and an allocation signal from a handover gateway; and
a transmission module for transmitting a report signal to the handover gateway according to the handover request signal, a confirmation signal to the handover gateway according the determination signal, and the handover respond signal to the wireless apparatus;
wherein the receiving module allocates the service resource according to the allocation signal.

30. The handover control apparatus of claim 29, further comprising:
a determination module for determining whether the handover request signal is accepted according to the handover request signal and the linking resource statuses of a plurality of base stations; and
a signal generation module for generating the report signal according to the determination result.

31. The handover control apparatus of claim 29, further comprising:
a determination module for determining whether the wireless apparatus accepts the determination of the handover respond signal according to the determination signal; and
a signal generation module for generating the confirmation signal according to the determination result.

32. A computer readable medium storing a computer program to execute a handover control method of a wireless network, the handover method comprising steps of:
receiving a handover request signal from a wireless apparatus;
transmitting a report signal to a handover gateway according to the handover request signal;
receiving a handover respond signal from the handover gateway;
transmitting the handover respond signal to the wireless apparatus;
receiving a determination signal from the wireless apparatus;
transmitting a confirmation signal to the handover gateway according to the determination;
receiving an allocation signal from the handover gateway; and
allocating the service resource according to the allocation signal.

33. The computer readable medium of claim 32, the method further comprising the steps of:
determining whether the handover request signal is accepted according to the handover request signal and the linking resource statuses of a plurality of base stations; and
generating the report signal according to the determination result.

34. The computer readable medium of claim 32, the method further comprising the steps of:
determining whether the wireless apparatus accepts the decision of the handover respond signal according to the determination signal; and
generating the confirmation signal according to the determination result.
